(19) United States
(12) Patent Application Publication
(10) Pub. No.: US 2026/0070106 A1
(43) Pub. Date: Mar. 12, 2026

(54) CALENDERING MACHINE HAVING A WORKING ROLLER WITH MULTIPLE BACKING ROLLERS

(71) Applicant: INGECAL, CHASSIEU (FR)

(72) Inventor: Pedro PEREIRA REBELO, Echallon (FR)

(21) Appl. No.: 19/320,166

(22) Filed: Sep. 5, 2025

(30) Foreign Application Priority Data
Sep. 6, 2024 (FR) 2409463
Apr. 18, 2025 (FR) 2504194

(51) Int. Cl. B21B 1/24; H01M 4/04

(52) U.S. Cl. CPC B21B 1/24; H01M 4/0435

(57) ABSTRACT

The invention provides a calendering machine (1), as well as a calendering method, for calendering a strip (4), of the type including a first and a second work roll (10, 20), rotating respectively about a first and second axis (Y10, Y20) parallel to each other, the two work rolls being counter-rotating and defining a calendering gap (30) in which the strip (4) runs from upstream to downstream,
characterized by at least two backing rolls (11, 12), respectively upstream (11) and downstream (12), associated with the first work roll (10), parallel to each other, parallel to the first work roll (10) and each bearing against the first work roll (10), each at a bearing zone (C11, C12), respectively upstream (C11) and downstream (C12), both arranged on a side of the first work roll (10) opposite to the calendering gap relative to the first axis (Y10).

### TECHNICAL FIELD

The invention relates to the field of calendering machines. A calendering machine is used for calendering a strip that is to be calendered. Such a strip may be composed of a single sheet or layer, or of a superposition of at least two sheets or layers adjoined to each other face-to-face, the different sheets of the same strip possibly made of different materials. The operation of calendering the strip, which is performed in a calendering machine, aims in particular to calibrate the thickness of the strip, and/or to compact at least one layer of the strip, and/or to assemble different layers of the strip together.

Such a calendering machine may be used in particular for the manufacture of electrochemical cell components, in particular electrode components for electrochemical cells, particularly for electrochemical cells of electrical accumulator batteries.

### TECHNICAL BACKGROUND

In the field of manufacturing accumulator batteries, in particular of the lithium-ion type, it is known to manufacture electrode components comprising at least one metal support in the form of a metal sheet, and, at least on one face of the metal support, a layer of electrode material, by imposing on such components a calendering operation carried out in a calendering machine.

In particular, in certain applications, such a calendering machine may be used to manufacture an electrode component comprising a strip having a metal sheet, which may form a current collector for the electrochemical cell, and which may form a metal support, and having, at least on one face of the metal support, a layer of electrode material.

In some applications, such a machine could be used to manufacture a self-supporting layer of electrode material, which could then be put into use in the manufacture of an electrochemical cell. For example, such a machine could be used to manufacture a film from a powder, including a mixture comprising one or several powders, said film being for example calendered in the calendering machine in a film-forming operation by which the powder, introduced just upstream of the calendering gap, is calendered in the calendering gap to obtain, downstream of the calendering gap, a film formed from said powder or mixture comprising one or several powders, this film preferably having sufficient cohesion to form a self-supporting layer which can be handled downstream. In such applications, upstream of the calendering gap, the strip within the meaning of the present text therefore consists of a layer or quantity of powder or mixture comprising one or several powders, for example delivered by a metering device over a work width at the entrance to the calendering gap, the powder being still unagglomerated, or only partially agglomerated, the powder being agglomerated by calendering in the calendering gap to form the film which constitutes the strip downstream of the calendering gap.

In a known manner, a calendering machine includes a first work roll rotating about a first axis, and a second work roll rotating about a second axis parallel to the first axis of the first work roll. The two work rolls are counter-rotating and define between them a calendering gap in which the strip runs, in a running plane, along a running direction going from upstream to downstream. The distance between the axis of the two work rolls determines the thickness of the calendering gap, and therefore determines the calendering force which is imposed on the strip when it runs between the two work rolls through this calendering gap. This calendering force consists of a compressive force which is applied to the strip along a direction which is approximately perpendicular to the running plane of the strip between the two work rolls. This calendering force depends in particular on the thickness of the calendering gap relative to the thickness of the strip at the entrance of the calendering gap.

Controlling the thickness of the calendering gap is crucial for the quality of the calendering operation.

In a known manner, a calendering machine is designed to process a strip having a transverse dimension, perpendicular to the running direction in the running plane, which, depending on the machines, may be within the range of a few tens of centimeters, for example being within the range of 50 cm to 150 cm. One of the important issues in controlling the thickness of the calendering gap is that of controlling the deformations, in particular in bending, of the work rolls. For this, it is known to associate, with a given work roll, a backing roll which is parallel to this work roll and which bears against this work roll at a bearing zone arranged on a side of the work roll which is opposite the calendering gap with respect to the axis of this work roll.

In a usual configuration, each of the two work rolls is associated with its own backing roll, the axes of rotation of the two work rolls and of the two backing rolls being in this case all substantially coplanar in a plane perpendicular to the running direction.

A problem related to this coplanar arrangement lies in the geometric inaccuracies that can lead to forces that are not perfectly contained in the plane of the axes of the four rolls, which generates, on at least one of the work rolls, forces oriented along the running direction, which can cause relative displacements between the rolls. Such relative displacements can affect the thickness of the calendering gap between the work rolls, and can therefore affect the quality of the calendering operation.

According to one aspect, the invention therefore aims to propose a new design of a calendering machine which makes it possible to best control the thickness of the calendering gap, in order to obtain optimal quality of the calendering operation.

Furthermore, in such machines, it is common for at least two rolls, for example a work roll and a backing roll, or both work rolls, to be driven in rotation about their axis each by an electric motor. In this case, the two rolls are generally mechanically linked to each other in their respective rotation, for example due to the contact between a work roll and an associated backing roll, or due to the fact that the strip circulates in contact between the two work rolls. In all cases, it is preferable to limit or even avoid any slippage at the contact between the two rolls. This poses difficulties in the control/command of the electric motors, in particular for regulating the speed of the electric motors. It is noted that conventional regulation methods sometimes result in one or the other of the motors seeing its control electric current take negative values, which is detrimental to the stability of the regulation.

According to another aspect, the invention therefore aims to propose a method for controlling the electric motors driving the rolls which allow stable regulation of their speed.

### DISCLOSURE OF THE INVENTION

Calendering machines are proposed for calendering a strip to be calendered, of the type including a first work roll rotating about a first axis and a second work roll rotating about a second axis parallel to the first axis, the two work rolls being counter-rotating and defining between them a calendering gap in which the strip runs in a running plane along a running direction from upstream to downstream. In the present text, the terms first and second, associated with the different rolls, are purely arbitrary to distinguish two rolls which have the same functionality in the machine.

In such types of machine, the calendering machine includes, associated with the first work roll, at least two backing rolls, respectively upstream and downstream, which are parallel to each other, which are parallel to the first work roll and which each bear against the first work roll, each at a bearing zone, respectively upstream and downstream, both arranged on a side of the first work roll which is opposite the calendering gap with respect to the first axis. Thus, in addition to limiting the bending of the work roll which could be caused by the calendering forces, the backing rolls can stabilize the work roll with which they are associated, in particular along the running direction. By reinforcing the holding of the two work rolls, the aim is to increase the precision and regularity of the calendering operation.

In some examples, each backing roll associated with the first work roll has an external bearing surface that bears on the associated work roll, and the shortest distance between the external bearing surface of the upstream backing roll and the running plane is greater than the shortest distance between the external bearing surface of the downstream backing roll and the running plane. Such an arrangement increases, along a direction perpendicular to the running plane, the free space available just upstream of the calendering gap, despite the presence of two backing rolls associated with this work roll, in particular despite the presence of the upstream backing roll. This increased available space makes it possible, for example, to accommodate other elements of the calendering machine as close as possible to the calendering gap.

In some examples, the machine has a first upstream tangent plane, tangent on the downstream side to both the first work roll and the associated upstream backing roll, which forms a first upstream clearance angle with the running plane, and a first downstream tangent plane, tangent on the downstream side to both the first work roll and the associated downstream backing roll, which forms a first downstream clearance angle with the running plane, and in that the first upstream clearance angle is greater than the first downstream clearance angle. Such an arrangement also contributes to increasing the free space available upstream of the calendering gap, despite the presence of the upstream backing roll.

In some examples, the bearing zones of the two backing rolls associated with the first work roll are angularly spaced from each other, about the first axis, by a first bearing spacing angle which is within the range of 30 to 120 degrees, preferably within the range of 60 to 100 degrees. Such an angular spacing ensures effective stabilization of the work roll along the running direction, while making it possible to keep free space available upstream of the calendering gap.

In some examples, the bearing zones of the two backing rolls associated with the first work roll are disposed symmetrically with respect to each other on either side of a work plane comprising the first axis and the second axis. Such symmetry makes it possible to ensure the stabilization of the work roll in both ways along the running direction.

In some examples, the bisector of the first bearing spacing angle has a direction that is inclined downstream away from the running plane. This results in an asymmetry of the contact areas relative to the work plane, which promotes an increase in the free space available upstream of the calendering gap.

In some examples, the two backing rolls associated with the first work roll are of the same diameter. They then have the same resistance to bending forces. On the contrary, in some examples, the upstream backing roll associated with the first work roll has an external diameter which is smaller than the external diameter of the downstream backing roll associated with the first work roll.

In some examples, the first work roll and the two backing rolls associated with the first work roll are each rotatably mounted on the same first support with a fixed center distance between them. Mounting on the same support makes it possible to guarantee the relative position of the rolls with respect to each other. In some such examples, the machine includes a frame, and the first support is movable relative to the frame, perpendicular to the running plane. Thus, the thickness of the calendering gap can be adjusted without altering the quality of the bearing provided by the backing rolls.

In some examples, the second axis is fixed relative to the frame. This makes it possible in some cases to reduce the number of actuators and guide means. On the contrary, in some examples, the second work roll is rotatably mounted about the second axis on a second support which is movable relative to the frame, perpendicular to the running plane. This allows in some cases to have a symmetrical adjustment of the thickness of the calendering gap, without moving the running plane.

In some examples, the calendering machine includes, associated with the second work roll, a single backing roll which is parallel to the second work roll and which bears against the second work roll at a bearing zone arranged on a side of the second work roll which is opposite the calendering gap with respect to the second axis. In some cases, this allows the cost of the machine to be reduced.

In some examples, the calendering machine includes, associated with the second work roll, two backing rolls, respectively upstream and downstream, which are parallel to each other, which are parallel to the second work roll and which each bear against the second work roll, each at a bearing zone, respectively upstream and downstream, arranged on a side of the second work roll which is opposite the calendering gap with respect to the second axis. By reinforcing the holding of the two work rolls, the precision of the calendering operation is increased.

In some examples, the two work rolls are of the same diameter; the two backing rolls associated with the first work roll form a first backing group; the two backing rolls associated with the second work roll form a second backing group; and the first backing group and the second backing group are symmetrical to each other on either side of the running plane. By having symmetrical backing groups, it is ensured that the machine is efficient for a wide variety of calendering operations, which can, for example, implement strips of different types.

In some examples, a considered work roll is movable relative to the associated backing group between a relative closed position in which the considered work roll and the two backing rolls associated with the considered work roll are in a relative contact position, and a relative spaced-apart position in which the considered work roll and the two backing rolls associated with the considered work roll are in a relative spaced-apart position. This can, for example, facilitate maintenance operations, in particular maintenance of the rolls.

In some examples, the considered work roll is rotatably mounted on a corresponding work support; the two backing rolls associated with the considered work roll are each rotatably mounted about its own axis on a corresponding backing support and the at least one of the work support and of the corresponding backing support is carried by a guide mechanism, by which the corresponding work support is movable relative to the corresponding backing support between a relative closed position in which the considered work roll and the two backing rolls associated with the considered work roll are in a relative contact position, and a relative spaced-apart position in which the considered work roll and the two backing rolls associated with the considered work roll are in their relative spaced-apart position. The guide mechanism allows precise positioning of the backing rolls relative to the considered work rolls.

In certain examples, the work support corresponding to the considered roll is movable, relative to the corresponding backing support and relative to a frame of the machine.

In some examples, the guide mechanism is carried by the backing support corresponding to the considered work roll and the corresponding work support is mounted on the corresponding backing support through the guide mechanism which is carried by the corresponding backing support and which is separate from a frame of the machine. This allows even more precise positioning of the backing rolls relative to the considered work roll.

In some examples, the work roll and the corresponding work support are without direct guidance on the frame of the machine, which promotes this precision.

In some examples, the backing support corresponding to the considered work roll is movable relative to the frame and the guide mechanism is movable with the backing support relative to the frame.

In some examples, the guide mechanism is carried by the frame of the machine and the work support is mounted on the frame through the guide mechanism. This allows precise positioning of the backing rolls relative to the considered work rolls, but here with great rigidity, which limits the risks of deformation under significant forces.

In some examples, the guide mechanism allows a single degree of freedom of the first work support relative to the first backing support.

In some examples, the first guide mechanism only allows a translation of the first work support relative to the first backing support in a radial direction perpendicular to the first axis and parallel to a calendering plane containing the two axes of the two work rolls. This makes it possible to produce a rigid and precise guide mechanism at reasonable cost.

Furthermore, various methods are proposed for calendering a strip to be calendered, of the type in which the strip is caused to run, in a running plane along a running direction from upstream to downstream, through a calendering gap defined between a first work roll rotating about a first axis and a second work roll rotating about a second axis parallel to the first axis, the two work rolls being counter-rotating.

In such types of method, the method includes the application, on the first work roll, of at least two backing rolls, respectively upstream and downstream, which are parallel to each other, which are parallel to the first work roll and which each bear against the first work roll, each at a bearing zone, respectively upstream and downstream, both arranged on a side of the first work roll which is opposite the calendering gap with respect to the first axis.

In some examples of such methods, each backing roll associated with the first work roll has an external bearing surface which bears on the associated work roll, and the two backing rolls are applied to the work roll such that the shortest distance between the external bearing surface of the upstream backing roll and the running plane is greater than the shortest distance between the external bearing surface of the downstream backing roll and the running plane.

In some examples of such methods, the bearing zones of the two backing rolls associated with the first work roll are angularly spaced from each other, about the first axis, by a first bearing spacing angle which is within the range of 30 to 120 degrees, preferably within the range of 60 to 100 degrees.

In some examples of such methods, the bearing zones of the two backing rolls associated with the first work roll are disposed symmetrically with respect to each other on either side of a work plane comprising the first axis and the second axis.

In some examples of such methods, the bisector of the first bearing spacing angle has a direction that is inclined downstream away from the running plane.

In some examples of such methods, the two backing rolls associated with the first work roll are of the same diameter.

In some examples of such methods, the upstream backing roll associated with the first work roll has an external diameter that is smaller than the external diameter of the downstream backing roll associated with the first work roll.

In some examples of such methods, the first work roll and the two backing rolls associated with the first work roll have a fixed center distance between them.

In certain examples of such methods, the first work roll and the two backing rolls associated with the first work roll are movable as a single unit, perpendicular to the running plane.

In some examples of such methods, the second axis is fixed.

In some examples of such methods, the second work roll is movable, perpendicular to the running plane.

In some examples of such methods, the calendering method includes applying, bearing against the second work roll, a single backing roll which is associated with the second work roll, which is parallel to the second work roll, and which bears against the second work roll at a bearing zone arranged on a side of the second work roll which is opposite the calendering gap with respect to the second axis.

In certain examples of such methods, the calendering method includes applying, bearing against the second work roll, two backing rolls, respectively upstream and downstream, which are associated with the second work roll, which are parallel to each other, which are parallel to the second work roll and which each bear against the second work roll, each at a bearing zone, respectively upstream and downstream, both arranged on a side of the second work roll which is opposite the calendering gap with respect to the second axis.

In some examples of such methods, the two work rolls are of the same diameter; the two backing rolls associated with the first work roll form a first backing group; the two backing rolls associated with the second work roll form a second backing group, and the first backing group and the second backing group are symmetrical to each other on either side of the running plane.

In some examples of such machines or methods, the strip to be calendered is an electrode component for electrochemical cells, comprising a layer of electrode material, in particular an electrode component comprising a layer of electrode material supported on a support layer or a self-supporting layer of electrode material.

In some examples of such machines or methods, the layer of electrode material is, in the calendering method, calendered alone or on a support layer, optionally with the addition of heat, to give cohesion to the layer of electrode material, and/or to give it desired structural properties, and/or to give it desired tribological and/or rheological properties, and/or to give it desired dimensional properties and/or to assemble the layer of electrode material on a support layer.

### BRIEF DESCRIPTION OF THE DRAWINGS

FIG. 1 is a schematic view illustrating an example of a calendering machine.

FIG. 2 is a schematic view illustrating more particularly a first configuration of a calendering group of a calendering machine, comprising two backing rolls for each work roll, a work roll being movable relative to a frame of the machine along a direction perpendicular to the running plane.

FIG. 3 is a schematic view illustrating more particularly another configuration of a calendering group of a calendering machine, in which the two work rolls are movable relative to a frame of the machine, perpendicular to the running plane.

FIG. 4 is a schematic view illustrating more particularly another configuration of a calendering group of a calendering machine, comprising, associated with a first work roll, two backing rolls, and, associated with a second work roll, a single backing roll.

FIG. 5 is a schematic view illustrating more particularly another configuration of a calendering group of a calendering machine, comprising backing groups offset downstream.

FIG. 6 is a schematic view illustrating more particularly another configuration of a calendering group of a calendering machine, comprising backing groups having, associated with a given work roll, backing rolls of different diameters.

FIG. 7 is a schematic view illustrating more particularly another configuration of a calendering group of a calendering machine, in which the calendering group, similar to that of FIG. 5, has a running plane inclined with respect to the vertical and with respect to the horizontal.

FIG. 8 is a schematic view illustrating more particularly another configuration of a calendering group of a calendering machine in which the calendering group, similar to that of FIG. 6, has a running plane inclined with respect to the vertical and with respect to the horizontal.

FIG. 9 is a schematic view illustrating more particularly another configuration of a calendering group of a calendering machine, in which the calendering group, similar to that of FIG. 5, is associated with an extrusion die received at least in part between two backing rolls upstream of the calendering group.

FIG. 10 is a schematic view illustrating more particularly another configuration of a calendering group of a calendering machine, in which the calendering group, similar to that of FIG. 6, is associated with an extrusion die received at least in part between two backing rolls upstream of the calendering group.

FIG. 11 is a flow diagram illustrating an example of a calendering method.

FIG. 12 is a schematic view illustrating another example of a calendering machine, comprising two backing rolls for each work roll, each work roll being movable relative to the backing rolls associated with this work roll, along a direction perpendicular to the running plane, here illustrated in a relative spaced-apart position.

FIG. 13 is a schematic view illustrating the example of the calendering machine of FIG. 12, with each work roll in a relative contact position against the backing rolls associated with this work roll.

FIG. 14 is a schematic view illustrating another example of a calendering machine, comprising two backing rolls for each work roll, each work roll being movable relative to the backing rolls associated with this work roll, along a direction perpendicular to the running plane, here illustrated in a relative spaced-apart position, with means for guiding the work rolls directly relative to the frame.

FIG. 15 is a diagram illustrating a circuit for controlling the rotation of a work roll and of an associated backing roll, mechanically linked in rotation in particular by their contact, of a calendering machine according to an exemplary embodiment.

FIG. 16 is a diagram illustrating a circuit for controlling the rotation of two work rolls of a calendering machine according to an exemplary embodiment.

FIG. 17 is a diagram illustrating another circuit for controlling the rotation of a work roll with two associated backing rolls, and another work roll, mechanically linked in rotation with the first work roll, of a calendering machine.

FIG. 18 is a diagram illustrating a circuit for controlling the rotation of the two work rolls and of the two backing rolls associated with each work roll, of a calendering machine according to an exemplary embodiment.

FIG. 19 is a flow diagram illustrating an example of a method for controlling the rotation of the rolls of a calendering machine.

FIG. 20 is a flow diagram illustrating another example of a method for controlling the rotation of the rolls of a calendering machine.

FIG. 21 is a schematic illustration of an example of an installation for continuously producing a film formed from a self-supporting layer of a material obtained by calendering a powder.

### DETAILED DESCRIPTION

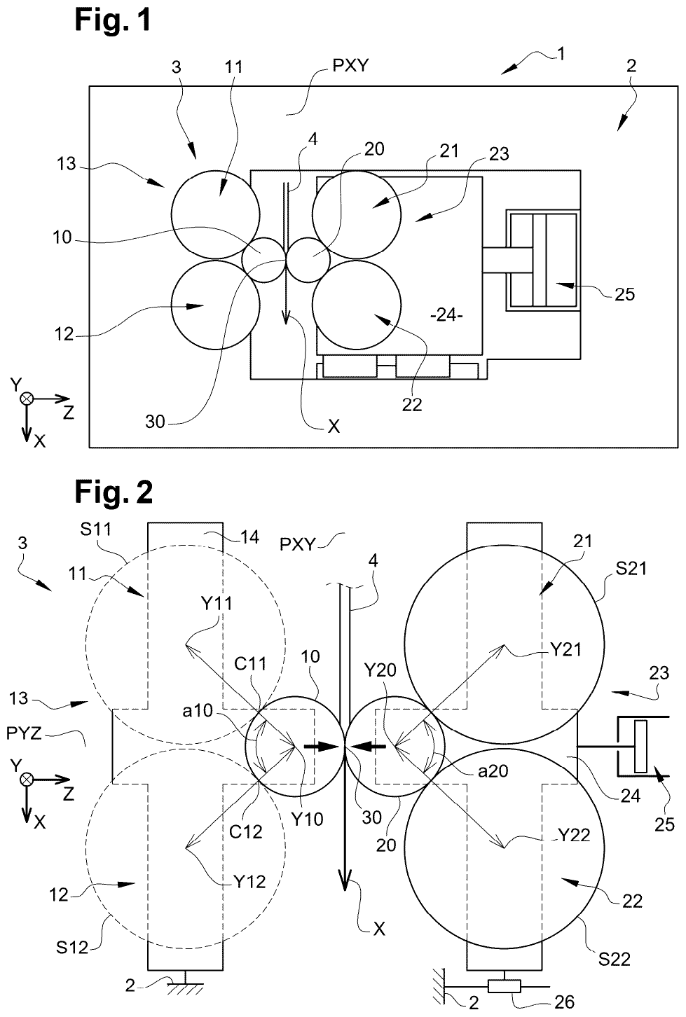

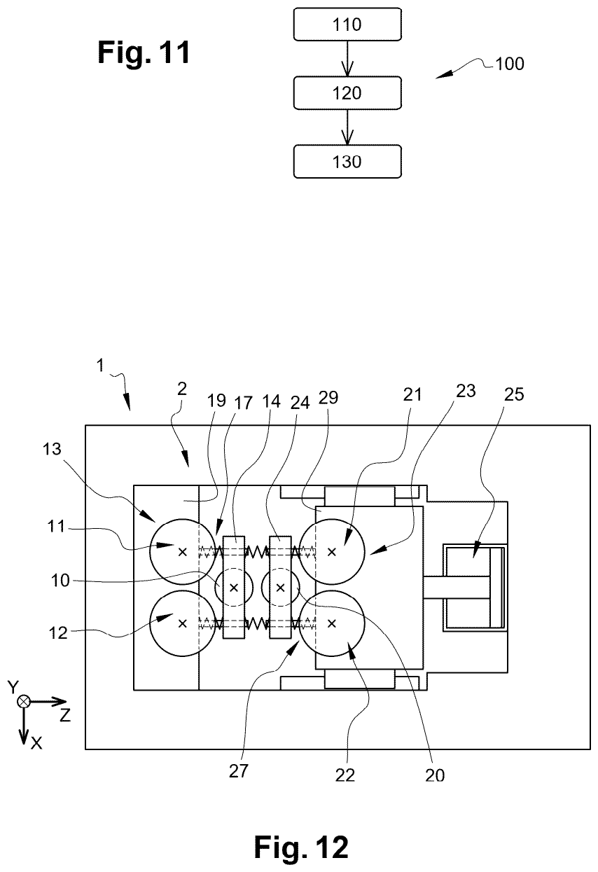

FIG. 1 illustrates a calendering machine 1 comprising at least one frame 2 and at least one calendering group 3. The calendering machine 1 is configured to be used for calendering a strip 4 that is to be calendered. Other examples will also be described with reference to FIGS. 12, 13 and 14.

In the example, the strip 4 is an electrochemical cell component, in particular an electrode component for electrochemical cells, particularly for electrochemical cells of electrical accumulator batteries, in particular of the lithium-ion type.

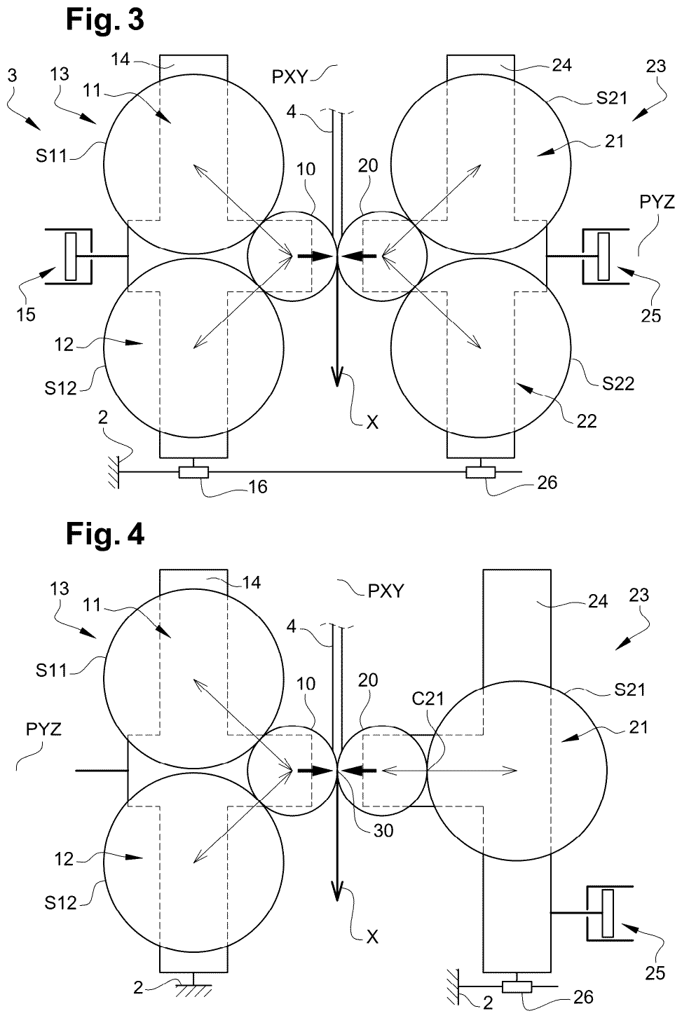

A first example of a calendering group 3 for such a calendering machine 1 is illustrated in FIG. 2. Other examples of a calendering group 3 are also illustrated in FIGS. 3 to 10 and in FIGS. 12, 13 and 14.

In all the illustrated examples, the calendering group 3 of the calendering machine 1 includes a first work roll 10 which is rotatable about a first axis Y10 and a second work roll 20 which is rotatable about a second axis Y20, the second axis Y20 being parallel to the first axis Y10 of the first work roll 10, within the limits of the usual manufacturing tolerances in the field. This parallelism is observed more particularly during operation of the machine in a calendering operation, when operating forces are applied to the rolls.

In the illustrated examples, the two work rolls 10, 20 are counter-rotating and they define between them a calendering gap 30 in which the strip 4 runs in a running plane PXY along a running direction X, in a way going from upstream to downstream in this direction. The running plane is parallel to the first axis Y10 of the first work roll 10 and to the second axis Y20 of the second work roll 20. In this running plane PXY, the running direction X is perpendicular to a transverse direction Y which is parallel to the first axis Y10 of the first work roll 10 and to the second axis Y20 of the second work roll 20.

The strip 4 may be composed of a single sheet, or of a superposition of at least two sheets adjoined to each other face-to-face. The strip 4 may be a discrete strip, having a length defined in the running direction, this length being within the range of magnitude of its width along a transverse direction parallel to the axes Y10, Y20 of the work rolls 10, 20, for example a length comprised between 0.1 and 10 times the width. Alternatively, the strip 4 may have an “infinite” length in the sense of a length greater than 10 times its width. For example, the strip may, upstream and/or downstream of the calendering machine 1, be wound in the form of a roll.

In applications for manufacturing electrochemical cell components, the strip 4 may have a thickness which, at the entrance to the calendering group 3, therefore upstream of the latter along the running direction X, is for example within the range of 0.05 mm to 2 mm. Generally, the calendering gap 30 has, at its location of minimum spacing along the direction Z perpendicular to the running plane PXY, a spacing between the two work rolls which is within the same range as the thickness of the strip 4 at the entrance of the calendering group 3, while being less than this, for example being equal to a value within the range of 95% to 10% of the thickness of the strip 4 at the entrance of the calendering group 3, preferably within the range of 90% to 60% of the thickness of the strip 4 at the entrance of the calendering group 3. The spacing between the two work rolls 10, 20 is the minimum distance between the external cylindrical surfaces of the two work rolls 10, 20.

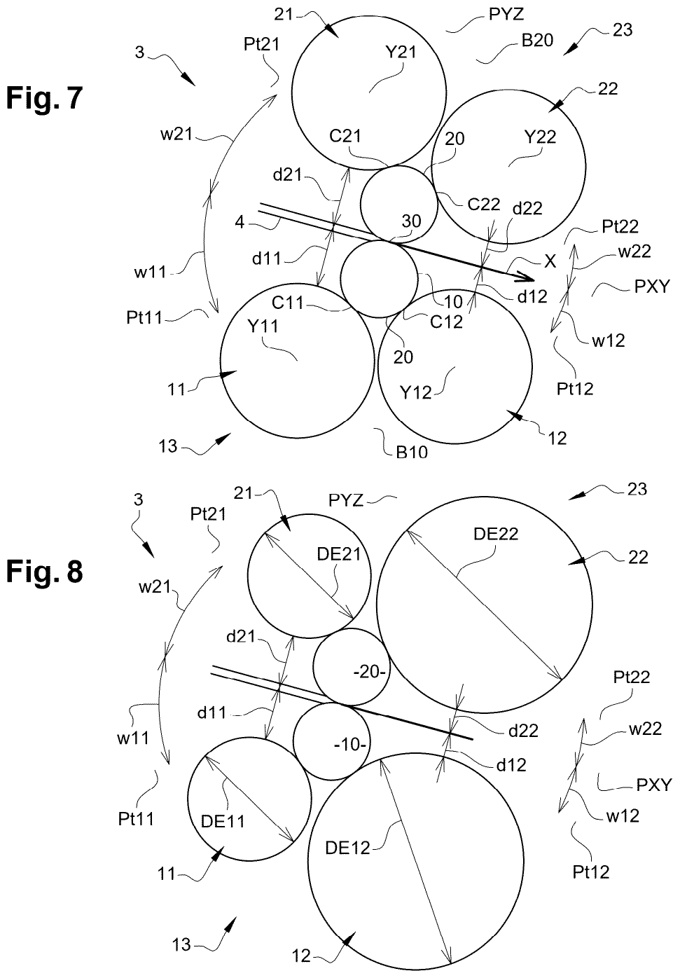

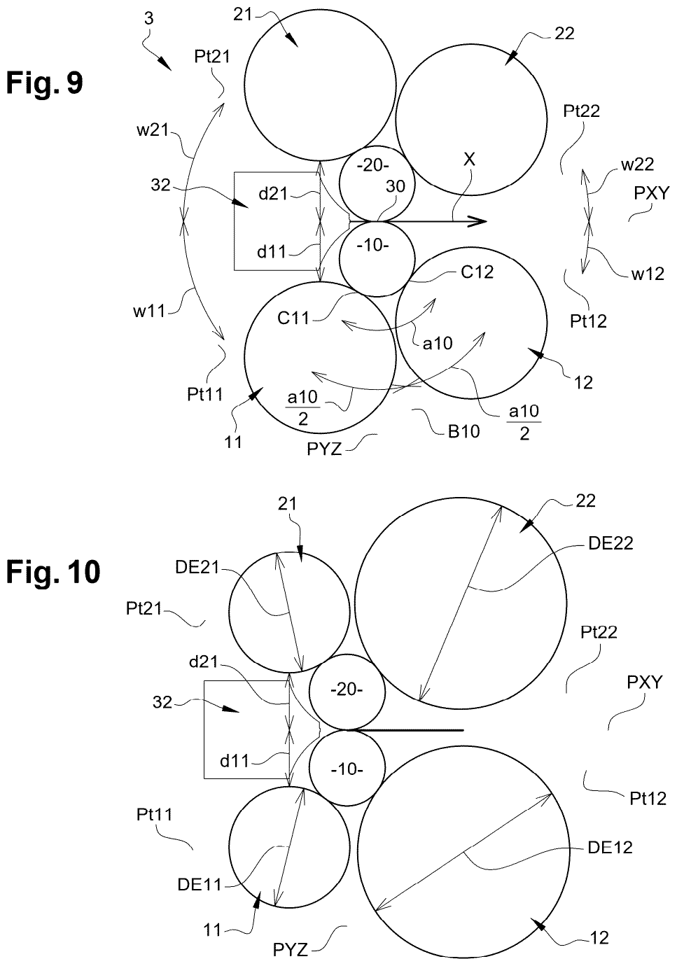

The orientation in space, with respect to the direction of Earth's gravity, of the different directions may vary depending on the applications and installations. For example, it may be considered that, in all the illustrated examples, the direction Y of the axes Y10, Y20 of the two work rolls 10, 20 is horizontal. In the examples of FIGS. 1 to 6, it may be considered that the running direction X is vertical. However, the same calendering machine and the same calendering group 3 may be implemented with a different orientation with respect to the direction of Earth's gravity. For example, it may be considered that in the example of FIGS. 9 and 10, the running direction X is horizontal, while the transverse direction Y of the axes Y10, Y20 of the two work rolls 10, 20 is also horizontal. However, the examples of FIGS. 9 and 10 can be implemented with a vertical running direction X, the transverse direction Y of the axes Y10, Y20 of the two work rolls 10, 20 being preferably horizontal. Still by way of example, it can be considered that in the example of FIGS. 7 and 8, the running direction X is inclined relative to the horizontal by an inclination angle which is less than 90 degrees, and which can for example be within the range of 5 to 45 degrees, while the transverse direction Y of the axes Y10, Y20 of the two work rolls 10, 20 is horizontal.

Preferably, each work roll 10, 20 is driven in rotation about its axis Y10, Y20 by drive means not represented in the figures. These drive means may comprise a motor, in particular an electric motor. Such a motor may be disposed coaxially along the axis of the considered work roll, for example at an axial end of the considered work roll, in the extension thereof. Alternatively, such a motor may be disposed in a position offset from the axis of the considered work roll, and may be connected thereto by a transmission mechanism comprising for example a chain, a belt, and/or a cascade of gears. In certain examples, we thus have the first work roll 10 which is driven in rotation about its axis Y10 by a first work motor M10, typically an electric motor, and the second work roll 20 which is driven in rotation about its axis Y20 by a second work motor M20, typically an electric motor. In some embodiments, one or several of the electric motors implemented to drive the rolls may be an electric stepper motor, a multi-phase asynchronous electric motor, or a synchronous electric motor.

In a known manner, the calendering machine 1 includes, associated with at least one of the work rolls 10, 20, a backing group 13, 23 comprising at least one backing roll 11, 12, 21, 22. Preferably, as in the illustrated examples, each work roll 10, 20 is associated with a backing group 13, 23 comprising at least one backing roll 11, 12, 21, 22 bearing on the considered work roll.

Generally, a backing roll of a backing group 13, 23, associated with a considered work roll 10, 20, is parallel to the considered work roll and bears against this work roll at a bearing zone which is arranged on a side of the work roll which is opposite the calendering gap 30 with respect to the axis of this work roll. The backing group 13, 23 has the function of limiting or compensating for the inevitable deformations of the work roll 10, 20 during operation in a calendering operation.

Within the limits of the usual manufacturing tolerances in the field, the backing roll is parallel to the associated work roll and bears on the latter at a bearing zone in the form of a straight line parallel to the axis of the considered work roll, at least when the calendering machine is in operation during an operation of calendering a strip, with the objective of having control of the thickness of the nip gap 30, over the entire axial length of the work rolls, in order to obtain a homogeneous treatment of the strip 4 over the entire axial direction Y thereof.

Likewise, within the limits of the usual manufacturing tolerances in the field, the work roll and the associated backing roll are cylinders of revolution with a rectilinear generatrix. However, a person skilled in the art of calendering machine design know that, for good control of this nip gap 30, it may be advantageous to provide that at least one of the work roll or one of the associated backing rolls, preferably the backing roll, has a slightly curved, barrel-shaped geometry, in order to compensate in whole or in part for any possible bending of the work roll during a calendering operation.

Likewise, the backing roll of a backing group 13, 23 is in many cases a continuous roll over its entire axial direction. However, a person skilled in the art knows that a considered backing roll can be segmented into different roll segments, successively aligned along the length of the axis of the backing roll.

According to a particularly advantageous aspect, it has been illustrated that, in all the illustrated examples, the calendering group 3 of the calendering machine 1 includes at least one first backing group 13 having, associated with the first work roll 10, at least two backing rolls, respectively upstream 11 and downstream 12, which are parallel to each other, which are parallel to the first work roll 10, and which each bear against the first work roll 10, each at a bearing zone, respectively upstream C11 and downstream C12, both arranged on a side of the first work roll 10 which is opposite the calendering gap 30 with respect to the first axis Y10. In other words, for each bearing zone, respectively upstream C11 and downstream C12, the angle formed, about the axis of the work roll, between the position of the bearing zone and the position of the calendering gap 30, is greater than 90 degrees.

In the running direction X, the upstream backing roll 11 is located upstream of the calendering gap 30, while the downstream backing roll 12 is located downstream of the calendering gap 30.

By providing that the work roll is associated with at least two backing rolls, the stability of the work roll can be greatly improved along a direction perpendicular to the running plane. This stability makes it possible to increase not only the stability against possible continuous or quasi-continuous displacement or deflection during the production phases, but also to increase the resistance to displacements or deflections of a vibratory nature during the production phases. Such an increase in the stability of the work roll along a direction perpendicular to the running plane makes it possible to increase the quality of the control of the spacing of the two work rolls in the calendering gap, to the benefit of the quality of the calendering operation.

Of course, in one variant not represented, the calendering machine 1 may include at least one first backing group having, associated with the first work roll, more than two backing rolls, including at least one third backing roll in addition to the upstream backing roll and to the downstream backing roll, which are parallel to each other, which are parallel to the first work roll, and which each bear against the first work roll, each at a bearing zone. For example, the first backing group may include a third backing roll bearing against the first work roll in an intermediate bearing zone arranged between the upstream bearing zone C11 and the downstream bearing zone C12. In certain embodiments, the intermediate bearing zone is for example arranged in a work plane PYZ comprising the first axis Y10 and the second axis Y20. In other embodiments, the intermediate bearing zone is for example offset relative to the work plane PYZ comprising the first axis Y10 and the second axis Y20.

Preferably, each backing roll 11, 12 of the first backing group 13 is driven in rotation about its axis Y11, Y12 by drive means not represented in FIGS. 1 to 15, but illustrated in FIGS. 16 to 18. These drive means may comprise a motor, in particular an electric motor M11, M12. Such a motor may be disposed coaxially along the axis of the considered backing roll, for example at an axial end of the considered backing roll, in the extension thereof. Alternatively, such a motor may be disposed in a position offset from the axis of the considered backing roll, and may be connected thereto by a transmission mechanism comprising for example a chain, a belt, and/or a cascade of gears. In some examples, we thus have the first upstream backing roll 11 which is driven in rotation about its axis Y11 by a first upstream backing roll motor M11, typically an electric motor, and the first downstream backing roll 12 which is driven in rotation about its axis Y12 by a first downstream backing roll motor M12, typically an electric motor. In some embodiments, one or several of the electric motors implemented for driving the rolls may be an electric stepper motor, a multi-phase asynchronous electric motor, or a synchronous electric motor.

In all the illustrated examples, with the exception of the example of FIG. 4, the calendering group 3 of the calendering machine 1 includes a second backing group 23 having, associated with the second work roll 20, two backing rolls, respectively upstream 21 and downstream 22, which are parallel to each other, which are parallel to the second work roll 20 and which each bear against the first work roll 10, each at a bearing zone, respectively upstream C21 and downstream C22, both arranged on a side of the second work roll 20 which is opposite the calendering gap 30 with respect to the second axis Y20. In other words, for each bearing zone, respectively upstream C21 and downstream C22, the angle formed, about the axis of the work roll, between the position of the bearing zone and the position of the calendering gap 30, is greater than 90 degrees.

In the running direction X, the upstream backing roll 21 is located upstream of the calendering gap 30, while the downstream backing roll 22 is located downstream of the calendering gap 30.

Preferably, each backing roll 21, 22 of the second backing group 23 is driven in rotation about its axis Y21, Y22 by drive means not represented in FIGS. 1 to 15, but illustrated in FIGS. 16 to 18. These drive means may comprise a motor, in particular an electric motor. Such a motor may be disposed coaxially along the axis of the considered backing roll, for example at an axial end of the considered backing roll, in the extension thereof. Alternatively, such a motor may be disposed in a position offset from the axis of the considered backing roll, and may be connected thereto by a transmission mechanism comprising for example a chain, a belt, and/or a cascade of gears. In certain examples, we thus have the second upstream backing roll 21 which is driven in rotation about its axis Y21 by a second upstream backing roll motor M21, typically an electric motor, and the second downstream backing roll 22 which is driven in rotation about its axis Y22 by a second downstream backing roll motor M22, typically an electric motor.

In all the illustrated examples except for the example of FIG. 4, the first backing group 13 and the second backing group 23 are symmetrical to each other on either side of the running plane PXY. This symmetry of course comprises the number of backing rolls of each backing group 13, 23, which is identical for both backing groups 13, 23. This symmetry also comprises that the position of the axes of the backing rolls is symmetrical on either side of the running plane PXY. This symmetry further comprises that the external diameter of a backing roll is identical to the external diameter of the corresponding backing roll in the symmetry.

In certain applications, it can be provided that the first backing group 13 and the second backing group 23 are not symmetrical, or in any case not entirely symmetrical to each other on either side of the running plane PXY.

In the example of FIG. 4, the calendering machine includes a second backing group 23 having, associated with the second work roll 20, a single backing roll 21 which is parallel to the second work roll 20 and which bears against the second work roll 20 at a bearing zone C21 which is arranged on a side of the second work roll 20 which is opposite the calendering gap with respect to the second axis Y20. For example, the bearing zone C21 of the single backing roll 21 on the second work roll 20 is diametrically opposite the calendering gap 30 with respect to the second axis Y20.

In the illustrated examples, the bearing zones C11, C12, respectively C21, C22, of the two backing rolls 11, 12, respectively 21, 22, associated with the first, respectively second, work roll are angularly spaced from each other, about the first axis Y10, respectively about the second axis Y20, by a first bearing spacing angle a10, respectively by a second bearing spacing angle a20, which is preferably within the range of 30 to 120 degrees, more preferably within the range of 60 to 100 degrees. Such an angle makes it possible to obtain good stability of the work roll along a direction perpendicular to the running plane. Within the range of considered values, the greater the bearing spacing angle a10, a20, the more backing rolls of larger diameter can be implemented, to the benefit of their rigidity and therefore their resistance to deformation. Within the range of considered values, by keeping the bearing spacing angle a10, a20 less than or equal to the upper limit of the range, the risk of the appearance of parasitic forces by wedge effect is limited, that is to say forces appearing by excessive engagement of the work roll between the two backing rolls.

In some embodiments, as illustrated for example in FIGS. 2 and 4, the first work roll 10 and the two backing rolls 11, 12 associated with the first work roll 10 are each rotatably mounted about their respective axes Y11, Y12 which occupy a fixed position relative to the frame 2 of the machine. The first work roll 10 and the two backing rolls 11, 12 have for example in this case a fixed center distance between them, at least in a production phase during which the machine is in operation to process a strip in order to give it the desired properties. It is noted that, even in the case of a first work roll 10 and of its two associated backing rolls 11, 12 having a fixed center distance between them in the production phase, it will be possible to advantageously provide means for adjusting their relative position, for a static adjustment of their relative position making it possible to ensure the required contact between the first work roll 10 and its two associated backing rolls 11, 12. Such a static adjustment will for example be performed in a machine adjustment phase, preferably outside a production phase.

In the embodiment of FIG. 3, the first work roll 10 and the two backing rolls 11, 12 associated with the first work roll 10 are each rotatably mounted on the same first support 14 with a fixed center distance between them, and the first support 14 is movable relative to the frame 2, perpendicular to the running plane PXY. Thus, the first work roll 10 and the two backing rolls 11, 12 associated with the first work roll 10 are movable as a single unit, in particular relative to the frame 2, perpendicular to the running plane PXY. For example, the first support 14 is connected to the frame 2 by a slide 16. In the illustrated example, the slide 16 allows a translation of the first support 14, and therefore of the first work roll 10 and its two associated backing rolls 11, 12, along a translation direction perpendicular to the running plane PXY. In this example, such a slide 16 allows a displacement purely along the translation direction perpendicular to the running plane PXY. However, other types of mechanical connection between the first support 14 and the frame can be provided, which ensure not a displacement purely in the translation direction perpendicular to the running plane PXY, but a displacement having a component along the translation direction perpendicular to the running plane PXY, preferably a majority component. Such a mechanical connection can for example be a parallelogram mechanical connection, an eccentric mechanical connection, etc.

Even in the case of a first work roll 10 and its two associated backing rolls 11, 12 mounted with a fixed center distance between them on a first support 14 movable relative to the frame 2, means for adjusting their relative position will advantageously be provided, for static adjustment of their relative position as described above.

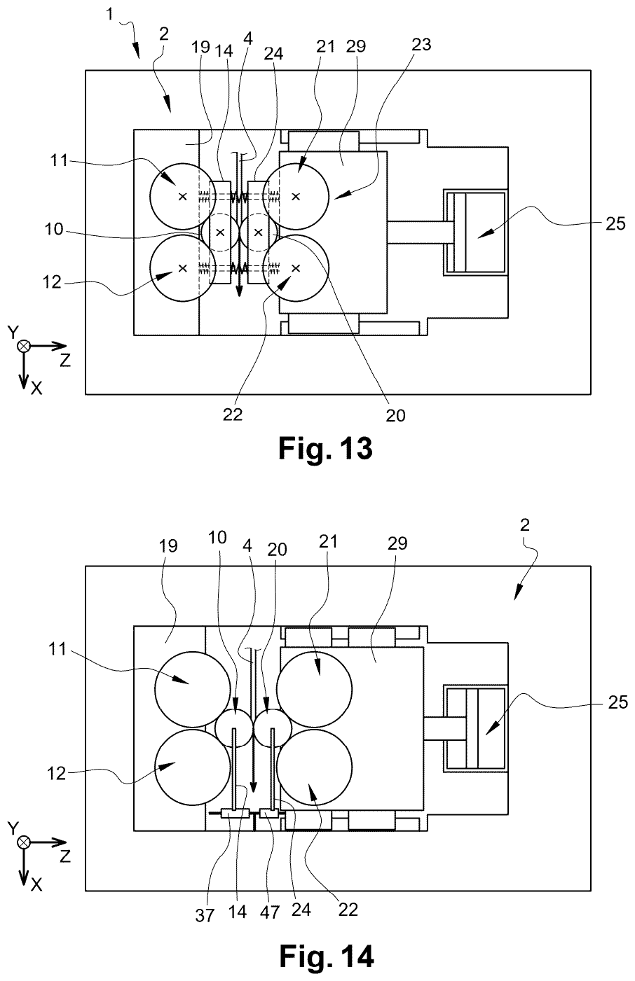

In the embodiments of FIGS. 12 to 14, two examples of machines have been illustrated in which the first work roll 10 is movable relative to the first backing group 13 between a relative closed position, which is illustrated in FIG. 13 for a first example and in FIG. 14 for the second example, in which the first work roll 10 and the two backing rolls 11, 12 associated with the first work roll 10 are in a relative contact position, which corresponds for example to a relative work position of the machine, and a relative spaced-apart position, which is illustrated only for the first example in FIG. 12, in which the first work roll 10 and the two backing rolls 11, 12 associated with the first work roll (10) are in a relative spaced-apart position, which corresponds for example to a relative rest and/or maintenance position of the machine.

In all the illustrated embodiments, at least one of the two work rolls 10, 20 is movable relative to the frame 2 of the machine, therefore movable relative to the other work roll. Of course, the backing group 13, 23 associated with a work roll 10, 20 movable relative to the frame 2, comprising a single backing roll or several backing rolls, is also movable relative to the frame 2, with the work roll movable relative to the frame.

In the examples of FIGS. 1 to 10, the backing group 13, 23 associated with a work roll movable relative to the frame, comprising a single backing roll or several backing rolls, is mounted, with the movable work roll 10, 20, on one support 14, 24 movable relative to the frame. For example, the movable support 14, 24 is connected to the frame 2 by a slide 16, 26, allowing for example a translation of the support 14, 24, along a translation direction perpendicular to the running plane PXY.

In the embodiments of FIGS. 2 and 4, the first work roll 10 and the two backing rolls 11, 12 associated with the first work roll 10 occupy a fixed position relative to the frame 2 of the machine, preferably with the possibility of static adjustment of their relative position, while the second work roll 20 is rotatably mounted about the second axis Y20 on a second support 24 which is movable relative to the frame 2, perpendicular to the running plane. Of course, a reverse mounting could be provided, with the second work roll 20 and the two backing rolls 21, 22 associated with the second work roll 20 occupying a fixed position relative to the frame 2 of the machine, preferably with the possibility of static adjustment of their relative position, while the first work roll 10 would be rotatably mounted about the first axis Y10 on a first support 14 which would be movable relative to the frame 2, perpendicular to the running plane PXY.

In some embodiments, such as that illustrated in FIG. 3, the two work rolls 10, 20 are movable relative to the frame 2 of the machine 1, and are movable relative to each other. Each backing group 13, 23, comprising one or two backing rolls 11, 12, 21, 22, is movable relative to the frame 2, with the associated work roll 10, 20. In such configurations, each backing group 13, 23 associated with a work roll, is preferably mounted, with the associated work roll, on a dedicated movable support 14, 24 which is movable relative to the frame.

In the examples of FIGS. 12 to 14, the first work roll 10 is rotatably mounted about the first axis Y10 on a first work support 14, while the two backing rolls 11, 12 associated with the first work roll 10 are each rotatably mounted about its own axis on a first backing support 19. At least one of the first work support 14 and of the first backing support 24 is carried by a first guide mechanism 17, 37, by which the first work support 14 is movable relative to the first backing support 19 between a relative closed position, illustrated in FIG. 13 for the first example and in FIG. 14 for the second example, in which the first work roll 10 and the two backing rolls 11, 12 associated with the first work roll 10 are in a relative contact position, and a relative spaced-apart position, illustrated only for the first example in FIG. 12, in which the first work roll 10 and the two backing rolls 11, 12 associated with the first work roll 10 are in their relative spaced-apart position.

It is noted that the first work support 14 is movable relative to the first backing support 19 and relative to the frame 2 of the machine.

In the example of FIGS. 12 and 13, the first guide mechanism 17 is carried by the first backing support 19 and the first work support 14 is mounted on the first backing support 19 through the first guide mechanism 17. The first guide mechanism 17 is carried by the first backing support 19 and is separate from the frame 2 of the machine. Thus, in this embodiment, the first work support 14 and the first work roll 10 are without direct guidance on the frame 2 of the machine.

For example, in the example of FIGS. 12 and 13, the first guide mechanism 17 includes at least one slide 17 comprising a guide rail and a carriage which is guided in translation on the guide rail, and one of the guide rail and of the carriage is fastened or formed on one of the first backing support 19 and of the first work support 14, while the other of the guide rail and of the carriage is fastened or formed on the other of the first backing support 19 and of the first work support 14.

In contrast, in the second example of FIG. 14, the first guide mechanism 37 is carried by the frame 2 of the machine and the first work support 14 is mounted on the frame 2 through the first guide mechanism 37, which includes for example a set of slides. Thus, in this example of FIG. 14, the first work support 14 is guided on the frame 2 independently of the first backing support 19. In some embodiments of the example of FIG. 14, the first guide mechanism 37 may comprise at least one slide comprising a guide rail and a carriage which is guided in translation on the guide rail, and one of the guide rail and of the carriage is fastened or formed on the frame 2 and the first work support 14, while the other of the guide rail and of the carriage is fastened or formed on the other of the frame 2 and of the first work support 14.

For both the example of FIGS. 12 and 13 and that of FIG. 14, the first guide mechanism 17, 37 may comprise at least two slides as described above, each arranged respectively on either side of the first work support 14 along the direction of the axis of the first work roll. Preferably, as illustrated in the example of FIGS. 12 and 13, but this can be transposed to the example of FIG. 14, the first guide mechanism 17, 37 may comprise at least two slides as described above, each arranged respectively on either side of the first work support 14 along the running direction X.

Preferably, both for the example of FIGS. 12 and 13 and for that of FIG. 14, the first guide mechanism 17, 37 may comprise at least four slides as described above, each arranged respectively on either side of the first work support 14 along the direction of the axis of the first work roll, and on either side of the first work support 14 along the running direction X.

In all cases, the first guide mechanism 17, 37 ensures precise and rigid guidance which prevents or greatly limits any possibility of misalignment of the first work roll 10. Preferably, the first guide mechanism 17, 37 ensures guidance with minimal friction along the guide direction.

In the two examples of FIGS. 12 to 14, the first backing support 19 is fixed relative to the frame 2. However, in other variants, the first backing support 19 is movable relative to the frame 2 and the first guide mechanism 17 is then movable with the first backing support 19 relative to the frame 2, in particular along the calendering direction Z for example under the effect of an actuator.

In both examples, the first guide mechanism 17, 37 allows a single degree of freedom of the first work support 14 relative to the first backing support 19. In this case, and by way of non-limiting example, the first guide mechanism 17, 37 only allows a translation of the first work support 14 relative to the first backing support 19 in a radial direction perpendicular to the first axis Y10 and parallel to the calendering plane PYZ containing the two axes Y10, Y20 of the two work rolls 10, 20.

In the examples of FIGS. 12 to 15, the second work roll 20 is rotatably mounted about the second axis Y20 on a second work support 24, while the two backing rolls 21, 22 associated with the first work roll 20 are each rotatably mounted about its own axis on a second backing support 29. At least one of the second work support 24 and of the second backing support 29 is carried by a second guide mechanism 27, 47, by which the second work support 24 is movable relative to the second backing support 29 between a relative closed position, illustrated in FIG. 13 for the first example and in FIG. 14 for the second example, in which the second work roll 20 and the two backing rolls 21, 22 associated with the second work roll 20 are in a relative contact position, and a relative spaced-apart position, illustrated only for the first example in FIG. 12, in which the second work roll 20 and the two backing rolls 11, 12 associated with the first work roll 10 are in their relative spaced-apart position.

For example, as illustrated in the figures, the second guide mechanism 27, 47 is identical to the first guide mechanism 17, 37 in symmetry with respect to the running plane PXY, and vice versa.

It is noted that the second work support 24 is movable relative to the second backing support 29 and relative to the frame 2 of the machine.

In the example of FIGS. 12 and 13, the second guide mechanism 27 is carried by the second backing support 29 and the second work support 24 is mounted on the second backing support 29 through the second guide mechanism 27 which is carried by the second backing support 29 and which is separate from the frame 2 of the machine. Thus, in this embodiment, the second work support 24 and the second work roll 20 are without direct guidance on the frame 2 of the machine.

For example, the second guide mechanism 27 includes at least one slide comprising a guide rail and a carriage which is guided in translation on the guide rail, and one of the guide rail and of the carriage is fastened or formed on one of the second backing support 29 and of the second work support 24, while the other of the guide rail and of the carriage is fastened or formed on the other of the second backing support 29 and of the second work support 24.

In the example of FIGS. 12 and 13, the second backing support 29 is movable relative to the frame 2 and the second guide mechanism 27 is then movable with the second backing support 29 relative to the frame 2. However, in certain embodiments in which the first backing support 19 is movable relative to the frame 2, the second backing support 29 may be fixed relative to the frame 2.

In both examples, the second guide mechanism 27, 47 allows a single degree of freedom of the second work support 24 relative to the second backing support 29. In this case, and by way of non-limiting example, the second guide mechanism 27, 47 only allows a translation of the second work support 24 relative to the second backing support 29 along a radial direction perpendicular to the second axis Y20 and parallel to the calendering plane PYZ containing the two axes Y10, Y20 of the two work rolls 10, 20.

For each case of a work roll 10, 20 movable relative to the frame 2 of the machine 1, for example mounted on a dedicated movable support 14, 24 which is movable relative to the frame, an actuator 15, 25 is preferably provided for controlling the relative position of the movable work roll 10, 20, where appropriate of its dedicated movable support 14, 24, relative to the frame 1 and relative to the other of the work rolls. The actuator 15, 25 is for example a hydraulic actuator, in particular a cylinder, or an electric actuator, such as a linear electric actuator. A transmission mechanism may be provided between the actuator 15, 25 and the movable work roll 10, 20, where appropriate its dedicated movable support 14, 24, for example a reduction and/or bevel gear mechanism. Preferably, the actuator 15, 25 makes it possible to dynamically adjust the relative position of the two movable rolls, including during a production phase, in order to adapt in real time the spacing between the two work rolls at the calendering gap 30, in particular to adapt to variations in calendering conditions as the strip 4 runs through the calendering gap 30.

In the embodiments of FIGS. 12 to 14, the second work roll 20 is movable relative to the second backing group 23 between a relative closed position, which is illustrated in FIG. 13 for a first example and in FIG. 14 for the second example, in which the second work roll 20 and the second backing rolls 21, 22 associated with the second work roll 20 are in a relative contact position, which corresponds for example to a relative work position of the machine, and a relative spaced-apart position, which is illustrated only for the first example in FIG. 12, in which the second work roll 20 and the two backing rolls 21, 22 associated with the second work roll 20 are in a relative spaced-apart position, which corresponds for example to a relative rest and/or maintenance position of the machine.

In these embodiments, the second work roll 20 is part of a movable assembly, for example being rotatably mounted about the second axis Y20 on a second work support 24 which is movable relative to the frame 2, perpendicular to the running plane PXY.

In these examples, the second work support 24 and the second backing support 29 are both movable relative to the frame 2 of the machine and movable relative to the first work roll 10, perpendicular to the running plane PXY, such that the movable assembly comprises the second work support 24, the second work roll 20, the second backing support 29 and the second backing rolls 21, 22.

In these examples, the second work support 24 is movable, perpendicular to the running plane PXY, relative to the second backing support 29 between a relative closed position, in which the second backing rolls 21, 22 and the second work roll 20 are in their relative contact position, and a relative spaced-apart position, in which the second backing rolls 21, 22 are radially spaced from the work surface of the second work roll 20.

In these examples, the connection between the second backing support 29 and the frame 2 allows a displacement of the second backing support 29, and therefore of the second backing rolls 21, 22, purely in the translation direction Z perpendicular to the running plane PXY. However, other types of mechanical connection between the second backing support 29 and the frame 2 can be provided, which ensure not a displacement purely in the translation direction perpendicular to the running plane PXY, but a displacement having a component in the translation direction perpendicular to the running plane PXY, preferably a majority component. Such a mechanical connection can for example be a parallelogram mechanical connection, an eccentric mechanical connection, etc.

In the embodiments of FIGS. 1 to 4, the bearing zones C11, C12, respectively C21, C22, of the two backing rolls 11, 12, respectively 21, 22, associated with the first work roll 10, respectively associated with the second work roll 20, are preferably disposed symmetrically with respect to each other on either side of the work plane PYZ comprising the first axis Y10 and the second axis Y20.

As a first approximation, the calendering forces which are applied by the work rolls 10, 20 on the strip 4 have a major component perpendicular to the running plane PXY, therefore in the work plane PYZ. Consequently, the reaction forces applied by the strip 4 on each of the work rolls have a major component perpendicular to the running plane PXY, therefore in the work plane PYZ. By providing a symmetrical arrangement of the bearing zones on either side of the work plane, it is ensured that these reaction forces, and therefore the resulting deformations of the work rolls, are taken up in a stable manner by the two backing rolls.

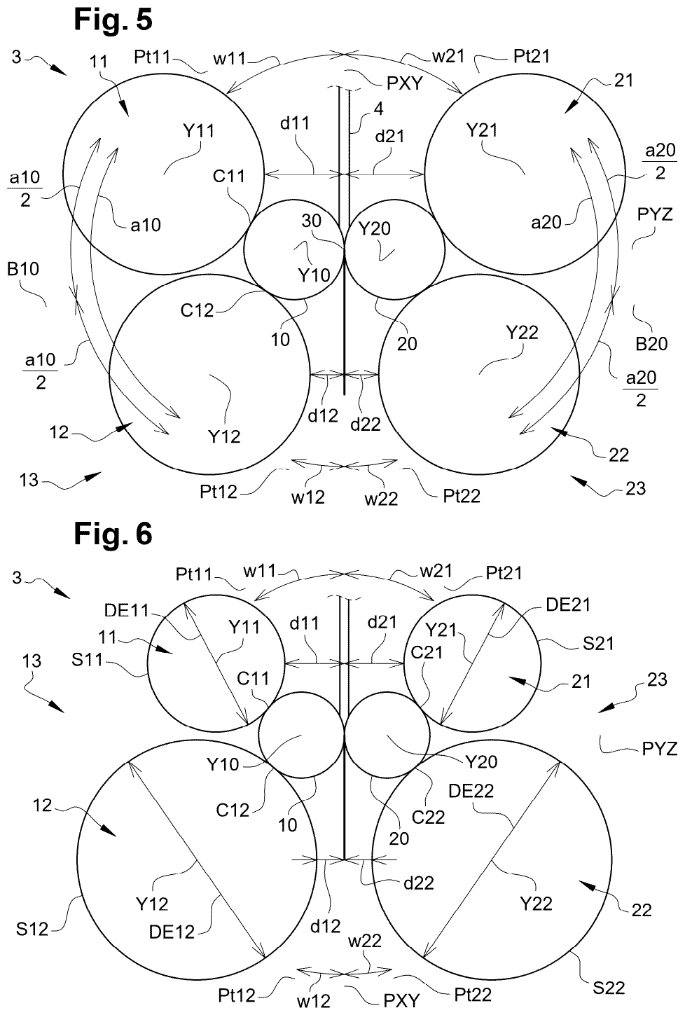

In the examples of FIGS. 5 to 10, different configurations of a backing group 13, 23 are provided, with for each of them an asymmetrical configuration of the backing group 13, 23 with respect to the work plane PYZ.

According to a first aspect common to these embodiments, it is more particularly considered that each backing roll 11, 12, 21, 22 associated with a given work roll, for example with the first work roll 10 or with the second work roll 20, has an external bearing surface S11, S12, S21, S22 which bears on the associated work roll. The external bearing surface S11, S12, S21, S22 of each backing roll 11, 12, 21, 22 is, at least as a first approximation, cylindrical of revolution with a rectilinear generatrix. The external bearing surface S11, S12, S21, S22 of each backing roll 11, 12, 21, 22 therefore has an external diameter which is the external diameter of the considered backing roll.

In all the examples of FIGS. 5 to 10, for at least one of the two backing groups 13, 13 of the calendering group 3, the backing group 13, 23 is configured so that the shortest distance d11, d21 between the external bearing surface S11, S21 of the upstream backing roll 11, 21 and the running plane PYZ is greater than the shortest distance d12, d22 between the external bearing surface S12, S22 of the downstream backing roll 12, 22 and the running plane PYZ.

In the examples comprising backing groups 13, 23, associated respectively with the first work roll 10 and with the second work roll 20, which are symmetrical with respect to the running plane PXY, it necessarily follows that the shortest distance d01=d11+d21 between the two upstream backing rolls 11, 21 which are associated respectively with the first work roll 10 and with the second work roll 20, is greater than the shortest distance d02=d12+d22 between the two downstream backing rolls 12, 22 which are associated respectively with the first work roll 10 and with the second work roll 20.

Such an arrangement has the particular advantage of freeing up space between the two upstream backing rolls 11, 21 which are associated respectively with the first work roll 10 and with the second work roll 20.

As illustrated in FIGS. 9 and 10, this space can advantageously be used to be able to dispose, as close as possible to the work rolls 10, 20, auxiliary equipment 32. In the examples of FIGS. 9 and 10, it can be seen that the increased space between the two upstream backing rolls 11, 21 can receive a die 32 for extruding a film or a die 32 for depositing a powder for forming a film, said film being intended for example to be calendered in the calendering machine. In such applications, this film forms the strip within the meaning of the present application.

Such a film may for example be a layer of electrode material which is either supported on a support layer, for example supported on a transfer film or supported directly on a metal sheet intended to form a current collector for an electrochemical cell, or self-supporting. In certain applications, such a film of electrode material may therefore be, in the calendering machine, calendered alone, possibly with the addition of heat, to give cohesion to the layer of electrode material, and/or to give it desired structural properties, and/or to give it desired tribological and/or rheological properties, and/or to give it desired dimensional properties. For example, the machine may be used to manufacture a film from a powder, said film being for example calendered in the calendering machine in a film-forming operation by which the powder, introduced just upstream of the calendering gap 30, is calendered in the calendering gap 30 to obtain, downstream of the calendering gap 30, a film formed from said powder, this film preferably having sufficient cohesion to form a self-supporting layer which can be handled downstream, and this film therefore being the strip within the meaning of the present application. In other applications, such a film of electrode material can therefore be, in the calendering machine, calendered onto a support layer, for example onto a metal sheet intended to form a current collector for an electrochemical cell, to assemble the layers to one another, and/or to give cohesion to the layer of electrode material, and/or to give the multilayer strip thus constituted the desired structural, tribological and/or rheological, and/or dimensional properties.

The electrode material may for example comprise an electrode active material associated with a binder, for example a fibrillable binder. The electrode active material may for example be or comprise a lithium metal oxide (for example of the NMC, NCA or LFP type) and/or graphite and/or activated carbon in the case of a cathode, or graphite or silicon in the case of an anode. The fibrillable binder may for example be or comprise polytetrafluoroethylene (PTFE), polyvinylpyrrolidone (PVP), polyvinylidene fluoride (PVDF), polyethylene oxide (PEO), polyethylene (PE) and/or carboxymethylcellulose (CMC), or a combination of these elements. The fibrillable binders can be characterized by their soft, flexible, and pliable consistency and, in particular, by their ability to stretch, elongate, and become thinner and take on a fibrous appearance when subjected to shear stresses.

Several arrangements are possible to achieve such a configuration of the backing group.

In the examples of FIGS. 5, 7 and 9, the two backing rolls of the same backing group 13, 23, therefore associated with the same work roll 10, 20, are offset downstream. Of course, the backing rolls are in contact with the work roll as disclosed above. In these examples, the bisector B10, B20 of the bearing spacing angle a10, a20 has a direction which is inclined downstream when moving away from the running plane PYZ. In other words, the bisector B10, B20 of the bearing spacing angle a10, a20 has a component, along the running direction, which is directed downstream when moving away from the running plane PYZ opposite the calendering gap 30 from the center of the considered work roll. In other words, for a given backing group 13, 23 associated with a given work roll 10, 20, the upstream bearing zone C11, C21, is closer to the work plane PYZ than the downstream bearing zone C12, C22. The bisector B10, B20 of the support deviation angle a10, a20 has a direction which is inclined downstream when moving away from the running plane PYZ by an angle which can be for example within the range of 3 to 35 degrees, preferably within the range of 5 to 20 degrees.

In the examples of FIGS. 5, 7 and 9, the two backing rolls associated with the same work roll are of the same diameter. However, in variants, it is possible to configure a backing group with two backing rolls associated with the same work roll which, while being offset downstream as in the examples of FIGS. 5, 7 and 9, have a different diameter, in particular with the upstream backing roll having an external diameter smaller than the external diameter of the downstream backing roll, as described below.

In the examples of FIGS. 6, 8 and 10, the calendering group 3 includes at least one first backing group 13 in which the upstream backing roll 11 associated with the first work roll 10 has an external diameter DE11 which is smaller than the external diameter DE12 of the downstream backing roll 12 associated with the first work roll 10. In these examples, the first backing group 13 and the second backing group 23 are symmetrical to each other on either side of the running plane PXY, so that, for the two backing groups 13, 23, the upstream backing roll 11, 21 has an external diameter DE11, DE21 which is smaller than the external diameter DE12, DE 22 of the downstream backing roll 12, 22. The difference in external diameter between the upstream backing roll 11, 21 and the downstream backing roll 12, 22 may for example be within the range of 5% to 40% of the external diameter of the downstream backing roll 12, 22, more preferably of 10% to 25% of the external diameter of the downstream backing roll 12, 22.

In the examples of FIGS. 6, 8 and 10, for a given backing group associated with a work roll, the upstream bearing zone C11, C21, is arranged at the same distance from the work plane as the downstream bearing zone C12, C22.

In the examples of FIGS. 5 to 10, it is noted that the configuration of the backing groups 13, 23 makes it possible to facilitate access, following the running direction X, to the calendering gap 30 by its upstream side. For each backing group 13, 23, it is possible to define an upstream tangent plane Pt11, Pt21, tangent on the upstream side both to the work roll 10, 20 and to the upstream backing roll 11, 21 associated with this work roll 10, 20. This upstream tangent plane Pt11, Pt21 forms an upstream clearance angle w11, w21, with the running plane PXY. It is also possible to define, for each backing group 13, 23, a downstream tangent plane Pt12, Pt22, tangent on the downstream side both to the work roll 10, 20 and to the downstream backing roll 12, 22 associated with this work roll 10, 20. This downstream tangent plane Pt12, Pt22 forms a downstream clearance angle w12, w22 with the running plane PXY. In the examples of FIGS. 5 to 10, for a given backing group 13, 23, the upstream clearance angle w11, w21 is greater than the downstream clearance angle w12, w22. As a result, access to the calendering gap 30 by its upstream side is facilitated, on at least one side of the running plane.

In these examples, the first backing group 13 and the second backing group 23 are symmetrical to each other on either side of the running plane PXY, so that, for the two backing groups 13, 23, the upstream clearance angle w11, w21 is greater than the downstream clearance angle w12, w22. In total, it results that the total upstream clearance angle w11+w21, between the two upstream tangent planes Pt11, Pt21 can be increased, and can in particular be greater than a total downstream clearance angle w12+w22, between the two downstream tangent planes Pt12, Pt22.

In general, the backing group associated with a given work roll makes it possible to reinforce the bending stiffness of the calendering group 3. It is noted that in the illustrated examples in FIGS. 5 to 10, the backing groups are not symmetrical with respect to the work plane PYZ. It is understood that in general, the bending stiffness of the calendering group 3, induced by these configurations, is greater when bending is downstream than upstream. This results from the downstream offset of the backing rolls and/or the implementation of a downstream backing roll of larger diameter. Now, in most calendering configurations, the reaction forces applied by the strip 4 on each of the work rolls have a major component perpendicular to the running plane PXY, therefore in the work plane PYZ, but also have a component parallel to the running plane PXY, oriented in the downstream direction. This is linked to the fact that, in the calendering operation, the thickness of the strip 4 upstream of the calendering gap 30 is greater than its thickness downstream of the calendering gap 30. By providing that the bending stiffness of the calendering group, induced by the configurations mentioned above, is greater when bending is downstream than upstream, the stiffness of the calendering group 3 is adapted in the direction so that it opposes the reaction forces applied by the strip 4 on each of the work rolls, thus reducing the bending of these work rolls while promoting accessibility to the calendering gap 30 by its upstream side.

Furthermore, here proposed are methods for calendering a strip 4 to be calendered, of the type in which the strip 4 is caused to run, in a running plane PXY along a running direction X from upstream to downstream, through a calendering gap 30 defined between a first work roll 10 rotating about a first axis Y10 and a second work roll 20 rotating about a second axis Y20 parallel to the first axis Y10, the two work rolls (10, 20) being counter-rotating.

These methods include applying, on the first work roll 10, at least two backing rolls 11, 12, respectively upstream 11 and downstream 12, which are parallel to each other, which are parallel to the first work roll 10 and which each bear against the first work roll 10, each at a bearing zone C11, C12, respectively upstream C11 and downstream C12, both arranged on a side of the first work roll 10 which is opposite the calendering gap with respect to the first axis Y10.

These methods are for example implemented with a calendering machine as described above.

An example of such a method 100 may, as illustrated in the flow diagram of FIG. 11, comprise providing 110 a strip 4 to be calendered upstream of a calendering gap 30 of a calendering machine 1. The method 100 comprises the step 120 of causing the strip 4 to run, in a running plane PXY, along a running direction X from upstream to downstream, through the calendering gap 30 defined between a first work roll 10 rotating about a first axis Y10 and a second work roll 20 rotating about a second axis Y20 parallel to the first axis Y10. The method 100 comprises the step 130 of applying, on the first work roll 10, at least two backing rolls 11, 12, respectively upstream 11 and downstream 12, which are parallel to each other, which are parallel to the first work roll 10 and which each bear against the first work roll 10, each at a bearing zone C11, C12, respectively upstream C11 and downstream C12, both arranged on a side of the first work roll 10 which is opposite the calendering gap 30 with respect to the first axis Y10.

The method may furthermore optionally comprise different steps and features which arise from the possible features of the calendering machine 1 as described above.

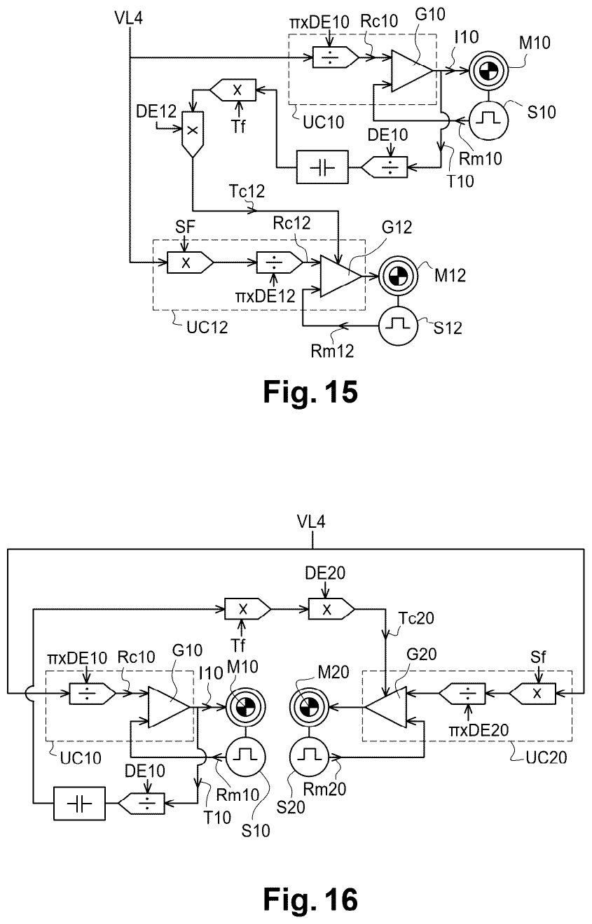

According to another aspect of the invention, the invention relates to a method 200, 300 for controlling the rotation of the rolls of a calendering machine 1, different variants of which are described in relation to FIGS. 15 to 20. This method may in particular be applied for controlling two rolls, or more than two rolls, whose respective rotational speeds are desired to be, at least for certain operating phases, in a predetermined fixed ratio. This method may in particular be applied for controlling two rolls, or more than two rolls, which are mechanically linked in rotation, either by direct contact, for example in the case of a work roll and an associated backing roll, or by indirect contact, in the case of two work rolls which are each in contact with one face of a strip running between the two work rolls. For the purposes of the present disclosure, two rolls are to be considered mechanically linked in rotation if the two rolls symbiotically perform a task such as supporting one roll of a pair subjected to external forces by the other roll, which is then a backing roll as described above, and/or carrying out a work step by a pair of work rolls, as described above (the work step being, for example, converting a powder into a film, densifying a web, cord, web or film, and/or laminating at least two layers, for example two webs, cords, webs and/or films, or the like).

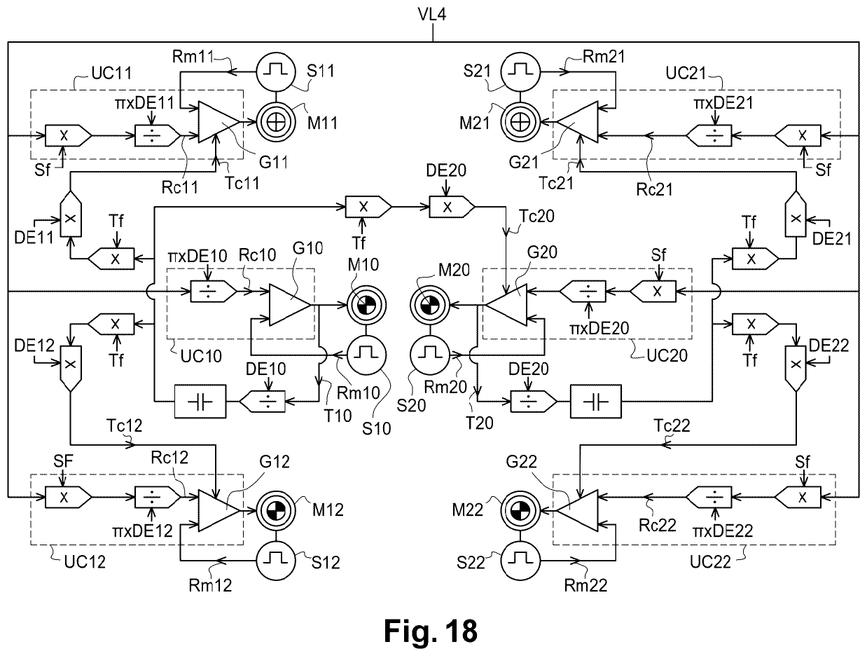

The method 200 is initially defined to apply to a work roll and at least one backing roll associated with this work roll, for example in a calendering machine 1 of the type already described previously. Referring to FIGS. 1 to 10, or 12 to 14, for the calendering machine 1, the calendering machine 1, to which the method 200, 300 is applied, includes a work roll 10 rotatable about a first axis Y10, and at least one backing roll 11, 12, which is parallel to the work roll 10 and which bears against the first work roll 10, at a bearing zone C11, C12, arranged on a side of the work roll 10. In the variant illustrated in FIG. 15, the at least one backing roll 12 is the only backing roll associated with the work roll 10. However, in other variants, as illustrated for example in FIG. 18 which will be commented on elsewhere, the at least one backing roll 12 may be one of several backing rolls 11, 12 each associated with said work roll 10, each being parallel and bearing against said work roll 10.

As shown schematically in FIG. 15, the calendering machine 1 further comprises a first work motor M10 for driving the first work roll 10, and a first backing roll motor M12 for driving the at least one backing roll 12. The calendering machine 1 further comprises a first work control unit UC10, for the speed control of the first work motor M10 and a first backing roll control unit UC12, for the speed and torque control of the first backing roll motor M12.

In this text, each electronic control unit controlling an electric motor for driving a work or backing roll may be or may comprise an electronic regulator of the proportional type, proportional-integral type, proportional-integral-derivative type, or other usual type. The electronic control unit may comprise electronic calculation and comparison circuits, one or more analog or digital inputs, one or more analog or digital outputs, one or more electronic memories, etc.

The first work control unit UC10 is for example functionally associated with a first work speed sensor S10 configured to measure a rotational speed Rm10 of the at least one work roll 10. The first work control unit UC10 is functionally associated with a first work torque estimator configured to determine a torque exerted T10 on the at least one work roll 10, on the axis thereof. The first torque estimator may be a separate element from the first work control unit UC10, with a direct or indirect communication link between the first torque estimator and the first work control unit UC10, or the first torque estimator may be integrated into the first work control unit UC10. The first work torque estimator may be implemented in the form of a torque sensor, or as in the example, by using information representative of the torque provided by the first work motor M10 on the axis of the considered roll 10. In the example, the work motor 10 is piloted, by the first control unit UC10, by an electric piloting current 110 whose electric intensity is representative of the torque T10 exerted by the first work motor M10 on the at least one work roll 10. The torque estimator will be able to take into account a reduction/multiplication ratio of a possible transmission between the work motor M10 and the work roll to determine the torque T10 applied to the axis of the work roll 10. The first torque estimator therefore uses, for example, an electrical intensity 110 representative of the torque exerted by the first work motor M10 on the at least one work roll 10, possibly multiplied by a reduction/multiplication ratio of a possible transmission between the motor and the roll.

The first backing roll control unit UC12 is for example functionally associated with a speed sensor S12 configured to measure a rotational speed Rm 12 of the at least one backing roll 12.

The first control unit UC10 and the first backing roll control unit UC12 are configured to communicate with each other, directly or indirectly, for example through an analog or digital communication link.

In the example of FIG. 15, the control system comprising the first work control unit UC10 and the first backing roll control unit UC12 receives a speed setpoint for the first work roll 10. In the example, this speed setpoint is a linear speed setpoint VL4, for example expressed in m/min, which represents a tangential speed setpoint for the first work roll 10 at its external work surface. Since the two rolls 10, 12 are in contact with each other and it is desired to avoid any slippage at this contact, it is understood that it is sought to obtain, for these two rolls 10, 12, the same tangential speed at their respective external surfaces which are in contact with each other.

In this example of FIG. 15, the system is designed to control the follower torque T12 exerted by the follower motor M12 on the at least one follower roll 20, here the first backing roll 12, to the main torque T10 exerted by the main motor M10 on the at least one main roll 10, here the first work roll 10. It can therefore be arbitrarily considered that the first work control unit UC10 is a main (or master) control unit, and that the first backing roll control unit UC12 is a follower control unit.

In the example we see that, for example upstream or within the first work control unit UC10, the linear speed setpoint VL4 is divided by a parameter representative of the diameter of the first work roll 10, in this case for example quite simply by Π(Pi) times the diameter DE10 of the first work roll 10, which makes it possible to obtain a rotational speed setpoint Rc10 for this first work roll 10, for example expressed in rpm, which rotational speed setpoint Rc10 is given as an input value for example to a regulator G10 of the first work control unit UC10. Preferably, the first work control unit UC10 also receives the information representative of the measured rotational speed Rm10 of the at least one first work roll 10, which can advantageously be used for closed-loop control of the rotational speed of the first work roll 10 by the first work control unit UC10. In this example, in which the system is designed to torque-control the rotation of the first backing roll 12 to that of the first work roll 10, the rotational speed setpoint Rc10 for this first work roll 10 is called the main (or master) rotational speed setpoint for the regulation. The regulator G10, which can here be referred to as the main (or master) regulator in the regulation, ensures that the first work motor M10 is piloted, by the first control unit UC10, for example by the electric piloting current 110, in such a way that the deviation between the rotational speed setpoint Rc10 for this first work roll 10 and the rotational speed Rm10 measured for this first work roll 10 is minimized.

In the example we see that, for example upstream or within the first backing roll control unit UC12, the linear speed setpoint VL4 is divided by a parameter representative of the diameter of the first backing roll 12, in this case for example quite simply by Π(Pi) times the diameter DE12 of the first work roll 12. But, moreover, according to a particular aspect, this linear speed setpoint VL4 is also multiplied, before or after the division by Π(Pi) times the diameter DE12, by a speed coefficient Sf which is for example greater than 1. The speed coefficient Sf is for example less than 1.5, for example comprised between 1.01 and 1.2, for example between 1.03 and 1.1. The speed coefficient Sf is for example fixed, but it could also be envisaged that this speed coefficient Sf is dependent on one or more parameters, for example dependent on the linear speed setpoint VL4. This double operation makes it possible to obtain a rotational speed setpoint Rc12 for this first backing roll 12, which is for example given as an input value to a regulator G12 of the first backing roll control unit UC12, which, preferably, also receives the information representative of the measured rotational speed Rm12 of the at least one first backing roll 12. In this example, in which the system is designed to control the rotation of the first backing roll 12 to the rotation of the first work roll 10, the rotational speed setpoint Rc12 for this first backing roll 12 is called the follower rotational speed setpoint for the regulation, and the regulator G12 of the first backing roll control unit UC12 is a follower regulator in the regulation. It can be noted that the follower rotational speed setpoint Rc12 is, in this example, independent of the measured rotational speed Rm10 of the main roll 10. The regulator G12 of the first backing roll control unit UC12 is for example of the same type or even identical to the regulator G10 of the first work control unit UC10.

According to another particular aspect, the follower control unit UC12, for example the follower regulator G12, also receives torque limit information Tc12 which aims to limit the torque setpoint which is supplied to the first backing roll motor M12, therefore which aims to limit the torque which is supplied by the first backing roll motor M12 to the first backing roll 12, on the axis thereof. More particularly, the torque setpoint which is supplied to the first backing roll motor M12 is such that, at the contact between the first work roll 10 and the first backing roll 12, the driving force due to the first backing roll motor M12 is less than the driving force due to the first work motor M10. This ensures that, of the two rolls 10, 12, the roll which is the main one in the regulation, here the first work roll 10, is never driven into overspeed by the follower roll which is here the first backing roll 12. Consequently, the first work motor M10, which is the main motor in the regulation, is not caused to provide, due to the mechanical coupling with the first backing roll, a negative braking torque, which promotes the precision and stability of the speed regulation of the first work roll 10. According to one embodiment, the main torque, here represented by the torque T10 exerted by the first work motor M10 on the axis of the first work roll 10, is multiplied by a torque coefficient Tf less than 1, to obtain a follower torque limit setpoint Tc12 for the follower roll, here constituted by the first backing roll 12. The torque coefficient Tf is for example greater than 0.5. The torque coefficient Tf is for example comprised between 0.8 and 0.99, for example comprised between 0.9 and 0.97.

For example, in the example of FIG. 15, a diameter ratio coefficient is also applied to take into account a possible difference in diameter between the main roll for the regulation, here for example the first work roll 10, and the follower roll for the regulation, here the first backing roll 12. Thus, the main torque, here the torque T10 exerted by the first work motor M10 on the first work roll 10, is divided by the diameter of the main roll, here the diameter DE10 of the first work roll 10 (or respectively half the diameter DE10), and multiplied by the diameter of the follower roll, here the diameter DE12 of the first backing roll 12 (respectively half the diameter DE12).

The calculation of the follower torque limit setpoint Tc12 for the follower roll, here constituted by the first backing roll 12, may take into account a reduction/multiplication ratio of a possible transmission between the first work motor M10 and the first work roll 10, and/or a reduction/multiplication ratio of a possible transmission between the first backing roll motor M12 and the first backing roll 12, this in order to determine the torque limit actually applied to the axis of the follower roll. For example, the torque generated by the motor on its own shaft will be multiplied/divided by a reduction/multiplication ratio of a possible transmission between the motor and the roll.

These multiplication and division operations, to obtain the follower torque limit setpoint Tc12 for the follower roll, here constituted by the first backing roll 12, can be carried out in any order. Filtering, for example of the averaging or low-pass type, can be carried out to smooth out any noise in the estimation of the main torque T10.

The first backing roll control unit UC12 ensures, for example by the follower regulator G12, that the first backing roll motor M12 is piloted, for example by the electric control current 112, so that the difference between the rotational speed setpoint Rc12 and the rotational speed Rm12 measured for this first backing roll 12 is minimized, while ensuring the limitation of torque applied to the axis of the first backing roll by following the follower torque limit setpoint Tc12.

With such a method, the first backing roll 12, which is the follower roll, is driven at a rotational speed such that the tangential speed of its external contact surface is as close as possible to the tangential speed of the external surface of the main roll to which it is mechanically linked, without exceeding it.

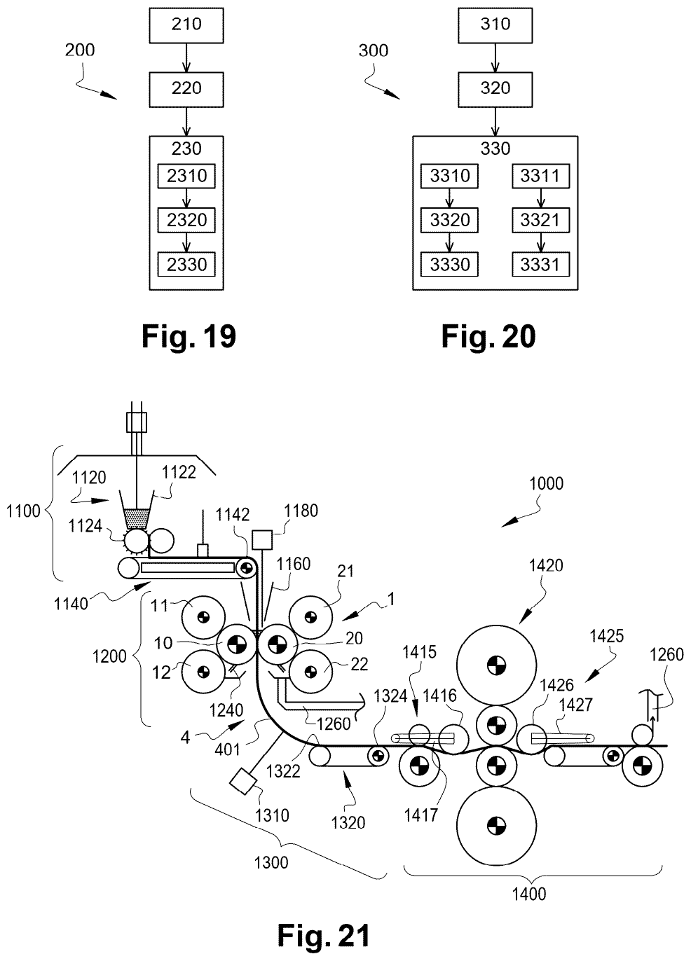

In the context of the example of FIG. 15, the method 200 for controlling the rotation of the main roll, here constituted by the first work roll 10, and of the follower roll, here constituted by the first backing roll 12, may comprise the following steps, illustrated schematically in FIG. 19.

As illustrated in FIG. 19, the control method 200 may comprise the step of controlling 210, by the main control unit UC10, the application by the main motor M10 of a rotational speed setpoint Rc10 of the main roll 10. The main roll 10 is therefore driven in rotation at the rotational speed which is equal to or very close to the rotational speed setpoint Rc10 for the main roll 10, such that its external surface has a linear tangential speed very close to or equal to the linear speed setpoint VL4, which is for example the desired running speed of the strip 4 in the calendering gap 30 or a speed very close. Typically, the rotational speed setpoint Rc10 of the first roll is selected such that the tangential speed of its external cylindrical surface is equal to the linear speed setpoint VL4.

The method 200 may comprise the step of calculating 220 a follower rotational speed setpoint Rc12 for the follower roll corresponding to the same tangential speed setpoint VL4, multiplied by a speed coefficient Sf greater than 1, as described above. The rotational speed setpoint Rc12 of the follower roll, here the first backing roll 12, is such that the tangential speed of its external cylindrical surface would be, if this speed setpoint were reached, greater than the linear speed setpoint VL4. However, the method is designed such that this rotational speed setpoint Rc12 of the follower roll, here the first backing roll 12, is not reached.

Indeed, the method 200 may comprise the step of repeating 230 the following steps, preferably according to a predetermined piloting frequency:
a. determining 2310 the main torque T10 exerted on the main roll 10 by the main motor M10, for example by the torque estimator as described above;
b. multiplying 2320 the main torque T10 by a torque coefficient Tf less than 1, to obtain a follower torque limit setpoint Tc12 for the follower roll 12;
c. controlling 2330, by the follower control unit UC12, the application by the follower motor M12 of the follower rotational speed setpoint Rc12 and the follower torque limit setpoint Tc12 for the follower roll 12.

Preferably, the predetermined piloting frequency is greater than 1000 Hz, preferably greater than or equal to 1 MHz. Thus, the main torque T10 exerted on the axis of the main roll 10 by the main motor M10 is determined at least every millisecond or at least every microsecond, so that it can be considered to be an instantaneous torque, and the regulation of the drive of the follower roll by the follower motor is also preferably carried out at least every millisecond or at least every microsecond, so that the speed of the follower roll and the torque applied to its axis can be considered to be adjusted in real time so that the main roll 10 is never driven by the follower roll 12 beyond its rotational speed setpoint Rc10. The frequency for determining the main torque and the frequency for controlling the follower motor are not necessarily identical. The considered control frequency will, for example, be the lower of these two frequencies.

In relation to FIG. 16, but still according to the sequence of FIG. 19, the method 200 is defined in a second variant to be applied to the two work rolls 10, 20 of a calendering machine, regardless of the presence or absence of backing rolls. The calendering machine is therefore of the type including a first work roll 10 rotating about a first axis Y10, which will hereinafter be considered as being the main roll, and a second work roll 20 rotating about a second axis Y20 parallel to the first axis Y10, which will hereinafter be considered as being the follower roll, the two work rolls 10, 20 being counter-rotating and defining between them a calendering gap 30 in which the strip 4 runs in a running plane PXY along a running direction X from upstream to downstream.

As schematically shown in FIG. 16, the calendering machine 1 further comprises a first work motor M10 for driving the first work roll 10, and a second work motor M20 for driving the second work roll 20. The calendering machine 1 further comprises a first work control unit UC10, for speed control of the first work motor M10 and a second work control unit UC20, for speed and torque control of the second work motor M20.

The second work control unit UC20 is for example functionally associated with a speed sensor S20 configured to measure a rotational speed Rm20 of the second work roll 20.

The first control unit UC10 and the second work control unit UC20 are configured to communicate with each other, directly or indirectly, for example through an analog or digital communication link.

In the example of FIG. 16, the control system comprising the first work control unit UC10 and the second work control unit UC20 receives a speed setpoint for the first work roll 10. In the example, this speed setpoint is a linear speed setpoint VL4, which represents the tangential speed setpoint for the first work roll 10 at its external work surface, therefore at the work space 30. Since these two work rolls 10, 20 are, during a work operation, indirectly in contact with each other via the strip 4, and since it is desired to avoid any shearing of the strip 4 at its contact with the two work rolls 10, 20, it is understood that it is sought to obtain, for these two work rolls 10, 20, the same tangential linear speed at their respective external surfaces which are in contact respectively with one and the other of the faces of the same strip 4.

In this example, the system is designed to control the follower torque T20 exerted by the follower motor M20 on the at least one follower roll 20, here the second work roll 20, to the main torque T10 exerted by the main motor M10 on the at least one main roll 10, here the first work roll 10. We can therefore arbitrarily consider that the first work control unit UC10 is a main (or master) control unit, and that the second work control unit UC20 is a follower control unit.

The first work control unit UC10 is designed and operates as in the variant of FIG. 15. It is, for example, identical to what was described in connection with FIG. 15. The second work control unit UC20 is, for example, identical to what was described in connection with FIG. 15 for the first backing roll control unit UC12 as a follower control unit.

In the example we see that, for example upstream or within the second work control unit UC20, the linear speed setpoint VL4 is divided by a parameter representative of the diameter of the second work roll 20, in this case for example quite simply by Π(Pi) times the diameter DE20 of the second work roll 20, to convert the tangential linear speed into rotational speed. But, moreover, according to a particular aspect, this linear speed setpoint VL4 is also multiplied, before or after the division by Π(Pi) times the diameter DE20, by a speed coefficient Sf which is for example greater than 1. The speed coefficient Sf is for example less than 1.5, for example comprised between 1.01 and 1.2, for example between 1.03 and 1.1. The speed coefficient Sf is for example fixed, but it could also be envisaged that this speed coefficient Sf is dependent on one or more parameters, for example dependent on the linear speed setpoint VL4. This double operation makes it possible to obtain a rotational speed setpoint Rc20 for this second work roll 20, which is for example given as an input value to a regulator G20 of the second work control unit UC20, which also receives the information representative of the measured rotational speed Rm20 of the second work roll 20. It can be noted that the follower rotational speed setpoint Rc20 is, in this example, independent of the measured rotational speed Rm10 of the main roll 10. In this example, in which the system is designed to torque-control the rotation of the second work roll 20 to the rotation torque of the first work roll 10, the rotational speed setpoint Rc20 for this second work roll 20 is called the follower setpoint speed for the regulation, and the regulator G20 of the second work control unit UC20 is a follower regulator in the regulation. The regulator G20 of the second work control unit UC20 is for example of the same type or even identical to the regulator G10 of the first work control unit UC10.

According to another particular aspect, the electronic follower control unit UC20, for example the follower regulator G20, also receives a torque limit information which aims to limit the torque setpoint which is supplied to the second work motor M20, which therefore aims to limit the torque which is supplied by the second work motor M20 to the second work roll 20, on the axis thereof. More particularly the torque limit setpoint which is supplied to the second backing roll motor M20 is such that, at the level of the calendering gap 30, the driving force, exerted by the second work roll 20 on the strip, due to the second work motor M20, is less than the driving force, exerted by the first work roll on the strip, due to the first work motor M10, therefore does not exceed it. This avoids introducing shear forces into the strip 4, while promoting the precision and stability of the speed regulation of the first work roll 10. According to one embodiment, the main torque, here represented by the torque T10 exerted by the first work motor M10 on the axis of the first work roll 10, is multiplied by a torque coefficient Tf less than 1, to obtain a follower torque limit setpoint Tc20 for the follower roll, here constituted by the second work roll 20. The torque coefficient Tf is for example greater than 0.5. The torque coefficient Tf is for example comprised between 0.8 and 0.99, for example comprised between 0.9 and 0.97.

For example, in the example of FIG. 16, a diameter ratio coefficient is also applied to take into account a possible difference in diameters between the main roll for regulation, here for example the first work roll 10, and the follower roll for regulation, here the second work roll 20. Thus, the main torque, here the torque T10 exerted by the first work motor M10 on the first work roll 10, is divided by the diameter of the main roll, here the diameter DE10 of the first work roll 10 (or respectively half the diameter DE10), and multiplied by the diameter of the follower roll, here the diameter DE20 of the second work roll 20 (respectively half the diameter DE20).

The calculation of the follower torque limit setpoint Tc20 for the follower roll, here constituted by the second work roll 20, may take into account a reduction/multiplication ratio of a possible transmission between the first work motor M10 and the first work roll 10, and/or a reduction/multiplication ratio of a possible transmission between the second work motor M20 and the second work roll 20, this in order to determine the torque limit actually applied to the axis of the follower roll. For example, the torque generated by the motor on its own shaft will be multiplied/divided by a reduction/multiplication ratio of a possible transmission between the motor and the roll.

These multiplication and division operations, to obtain the follower torque limit setpoint Tc20 for the follower roll, here constituted by the second work roll 20, can be carried out in any order. Filtering, for example of the averaging or low-pass type, can be carried out to smooth out any noise in the estimation of the main torque T10.

The electronic follower control unit UC20, for example by the follower regulator G20, ensures that the second work motor M20 is piloted, by the second backing roll control unit UC20, for example by the electric control current 120, so that the difference between the rotational speed setpoint Rc20 and the rotational speed Rm20 measured for this second work roll 20 is minimized, while ensuring the limitation of torque applied to the axis of the second work roll 20 by following the follower torque limit setpoint Tc20.

With such a method, the second work roll 20, which is the follower roll, is driven at a rotational speed such that the tangential speed of its external contact surface is as close as possible to the tangential speed of the external surface of the first work roll, without exceeding it.

In the context of the example of FIG. 16, the method 200 for controlling the rotation of the main roll, here constituted by the first work roll 10, and of the follower roll, here constituted by the second work roll 20, may comprise the following steps, illustrated schematically in FIG. 19.

As illustrated in FIG. 19, the control method 200 may comprise the step of controlling 210, by the main control unit UC10, the application by the main motor M10 of a rotational speed setpoint Rc10 of the main roll 10, as seen above for this step 210.

As already described in relation to FIG. 15, the method 200 may comprise the step of calculating 220 a follower rotational speed setpoint Rc20 for the follower roll corresponding to the same tangential speed setpoint VL4, multiplied by a speed coefficient Sf greater than 1, as described above. The rotational speed setpoint Rc20 of the follower roll, here the second work roll 20, is such that the tangential speed of its external cylindrical surface would be, if this speed setpoint were reached, greater than the linear speed setpoint VL4. However, the method is designed such that this rotational speed setpoint Rc20 of the follower roll, here the second work roll 20, is not reached.

Indeed, the method 200 can comprise the step of repeating 230 the following steps, preferably according to a predetermined control frequency:
a. determining 2310 the main torque T10 exerted on the main roll 10 by the main motor M10;
b. multiplying 2320 the main torque T10 by a torque coefficient Tf less than 1, to obtain a follower torque limit setpoint Tc20 for the follower roll 20;
c. controlling 2330, by the follower control unit UC20, the application by the follower motor M20 of the follower rotational speed setpoint Rc20 and the follower torque limit setpoint Tc20 for the follower roll 20.

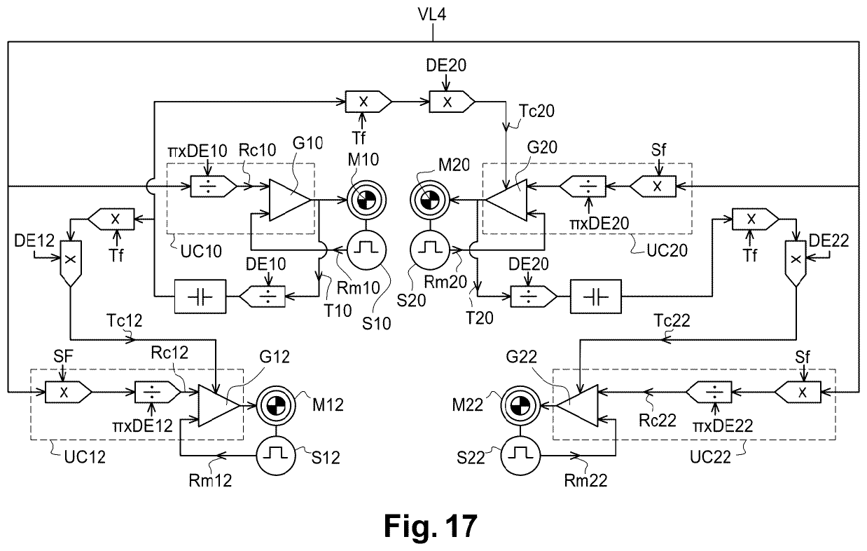

In relation to FIG. 17, but now according to the sequence of FIG. 20, the method 300 is defined in a third variant to be applied to the case of a calendering machine comprising two work rolls 10, 20, one of them being associated with at least one backing roll 22. In such a variant, the method 300 allows the control of the rotation of at least three rolls. The machine includes a main roll, for example the first work roll 10 in the example of FIG. 17, rotating about a first axis Y10, and at least one follower roll, for example the second work roll 20 in the example of FIG. 17. The calendering machine further includes at least one secondary follower roll, here a second backing roll 22, which is parallel to the follower roll 20 and which is, directly or indirectly, mechanically linked in rotation to the follower roll 20. In the variant illustrated in FIG. 17, the at least one secondary follower roll is a backing roll 22 which is the only backing roll associated with the work roll 20 forming here the follower roll. However, in other variants, as illustrated for example in FIG. 18 which will be commented on elsewhere, the at least one secondary follower roll 22 may be one of several backing rolls 21, 22 each associated with said work roll 20 forming here the follower roll, each being parallel and bearing against said work roll 20.

The calendering machine of FIG. 17 is therefore of the type including, as in the example of FIG. 16, a first work roll 10 rotating about a first axis Y10, which will hereinafter be considered as being the main roll, and a second work roll 20 rotating about a second axis Y20 parallel to the first axis Y10, which will hereinafter be considered as being the follower roll, the two work rolls 10, 20 being counter-rotating and defining between them a calendering gap 30 in which the strip 4 runs in a running plane PXY along a running direction X from upstream to downstream.

As regards the method 300 for controlling the two work rolls 10, 20 of the machine of FIG. 17, it is for example identical to that 200 described for these two rolls in the variant described in relation to FIG. 16, and will therefore not be repeated here, the steps 310, 320, and the steps 3310, 3320 and 3330 of the step 330 being respectively identical to the steps 210, 220, and to the steps 2310, 2320 and 2330 of the step 330, as described for the variant of FIG. 16.

The calendering machine 1 of FIG. 17 comprises a second backing roll motor M22, which here forms a secondary follower motor M22 for driving the at least one secondary follower roll, here the second backing roll 22. The calendering machine 1 further comprises a second backing roll control unit UC22, which forms a secondary follower control unit UC22 in speed and torque of the secondary follower motor M22. In this variant, the follower control unit UC20 is functionally associated with a follower torque estimator configured to determine a follower torque T20 exerted by the follower motor M20 on the at least one follower roll 20, which is only optional and not shown in the variant of FIG. 16. The follower torque estimator may be identical or similar to the first torque estimator described further, and may operate in an identical or similar manner, to determine in this case the follower torque T20. The follower torque estimator may be a separate element from the follower work control unit UC20, with a direct or indirect communication link between the two, or may be integrated into the follower work control unit UC20.

The follower control unit UC20, in this case the second work control unit UC20, and the secondary follower control unit UC22, in this case the second backing roll control unit UC22, are configured to communicate with each other directly or indirectly, for example via an analog or digital communication link.

In this variant of FIG. 17, the system is designed to control the secondary follower torque T22 exerted by the secondary follower motor M22 on the second backing roll 22, to the follower torque T20 exerted by the follower motor M20 on the at least one follower roll 20, here the second work roll 20, which is itself controlled by the main torque T10 exerted by the main motor M10 on the at least one main roll 10, here the first work roll 10.

In the variant illustrated in FIG. 17, it can be seen that, for example upstream or within the second backing roll control unit UC22, the linear speed setpoint VL4 is divided by a parameter representative of the diameter of the second backing roll 22, in this case for example quite simply by Π(Pi) times the diameter DE22 of the second backing roll 22. But, moreover, according to a particular aspect analogous to what has already been described for a follower roll, this linear speed setpoint VL4 is also multiplied, before or after the division by Π(Pi) times the diameter DE22, by a speed coefficient Sf which is for example greater than 1. The speed coefficient Sf is for example less than 1.5, for example comprised between 1.01 and 1.2, for example between 1.03 and 1.1. The speed coefficient Sf is for example fixed, but it could also be envisaged that this speed coefficient Sf is dependent on one or more parameters, for example dependent on the linear speed setpoint VL4. The speed coefficient Sf used by the secondary follower control unit UC22 can be the same as that used by the follower control unit UC20. This double operation makes it possible to obtain a rotational speed setpoint Rc22 for this secondary follower roll 22, which is for example given as an input value to a regulator G22 of the second backing roll control unit UC22. It can be noted that the secondary follower rotational speed setpoint Rc22 is, in this example, independent of the measured rotational speed Rm20 of the follower roll 20 independent of the measured rotational speed Rm10 of the main roll 10. Preferably, the second backing roll control unit UC22 also receives the information representative of the measured rotational speed Rm22 of the at least one second backing roll 22 forming a secondary follower roll. In this example, the rotational speed setpoint Rc22 for this second backing roll 22 is called the secondary follower rotational speed setpoint for the regulation, and the regulator G22 of the second backing roll control unit UC22 is a secondary follower regulator in the regulation. The regulator G22 of the second backing roll control unit UC22 is for example of the same type or even identical to the regulator G20 of the second work control unit UC20 which forms a follower control unit.

According to another particular aspect, the secondary follower control unit UC22, for example the secondary follower regulator G22, also receives a torque limit information which aims to limit the torque setpoint which is supplied to the second backing roll motor M22, therefore which aims to limit the torque which is supplied by the second backing roll motor M22 to the second backing roll 12, on the axis thereof. More particularly, the torque setpoint which is supplied to the second backing roll motor M22 is such that, at the contact between the second work roll 20 and the second backing roll 22, the driving force due to the second backing roll motor M22 is less than the driving force due to the second work motor M20. This ensures that, of the two rolls 20, 22, the roll which is the follower in the regulation, here the second work roll 20, is never driven into overspeed by the secondary follower roll which is here the second backing roll 12. Consequently, the second work motor M20, which is the follower motor in the regulation, is not caused to provide, due to the mechanical coupling with the second backing roll 22, a negative braking torque, which promotes the precision and stability of the speed regulation of the second work roll 20. According to one embodiment, the follower torque, here represented by the torque T20 exerted by the second work motor M20 on the second work roll 20, on the axis thereof, is multiplied by a torque coefficient Tf less than 1, to obtain a secondary follower torque limit setpoint Tc22 for the secondary follower roll, here constituted by the second backing roll 22. The torque coefficient Tf is for example greater than 0.5. The torque coefficient Tf is for example comprised between 0.8 and 0.99, for example comprised between 0.9 and 0.97. The torque coefficient Tf used to calculate the secondary follower torque limit setpoint Tc22 can be the same as that used to calculate the follower torque limit setpoint Tc20 as described above.

For example, in the example of FIG. 17, a diameter ratio coefficient is also applied to take into account a possible difference in diameter between the follower roll for the regulation, here for example the second work roll 20, and the secondary follower roll for the regulation, here the second backing roll 22. Thus, the secondary torque, here the torque T20 exerted by the second work motor M20 on the second work roll 20, is divided by the diameter of the follower roll (or respectively half of this diameter), here the diameter DE20 of the second work roll 20, and multiplied by the diameter of the secondary follower roll (respectively half of this diameter), here the diameter DE22 of the second backing roll 22. The calculation of the secondary follower torque limit setpoint Tc22 for the secondary follower roll, here constituted by the second backing roll 22, may take into account a reduction/multiplication ratio of a possible transmission between the second work motor M20 and the second work roll 20, and/or a reduction/multiplication ratio of a possible transmission between the second backing roll motor M22 and the second backing roll 22, this in order to determine the limit of torque actually applied to the axis of the secondary follower roll. For example, the torque generated by the motor on its own shaft will be multiplied/divided by a reduction/multiplication ratio of a possible transmission between the motor and the roll.

These multiplication and division operations, to obtain the secondary follower torque limit setpoint Tc22 for the secondary follower roll, here constituted by the second backing roll 22, can be carried out in any order. Filtering, for example of the averaging or low-pass type, can be carried out to smooth out any noise in the estimation of the follower torque T20.

The secondary follower electronic control unit UC22, for example through the secondary follower regulator G22, ensures that the second backing roll motor M22 is piloted, for example by the electric control current 122, so that the difference between the rotational speed setpoint Rc22 and the measured rotational speed Rm22 measured for this second backing roll 22 is minimized, while ensuring the limitation of torque applied to the axis of the second backing roll 22 by following the secondary follower torque limit setpoint Tc22.

In such a context, the method 300 may in particular comprise, as described previously, the step of repeating 330 the steps of
a. determining 3310 the main torque T10 exerted on the main roll 10 by the main motor M10;
b. multiplying 3320 the main torque T10 by a torque coefficient Tf less than 1, to obtain a follower torque limit setpoint Tc20 for the follower roll 20;
c. controlling 3330, by the follower control unit UC20, the application by the follower motor M20 of the follower rotational speed setpoint Rc20 and the follower torque limit setpoint Tc20 for the follower roll 20.

The method 300 may comprise the step of calculating 321 a secondary follower rotational speed setpoint Rc22 for the secondary follower roll corresponding to the same tangential speed setpoint VL4, multiplied by a speed coefficient Sf greater than 1, as described above. The secondary follower rotational speed setpoint Rc22 of the secondary follower roll, here the second backing roll 22, is such that the tangential speed of its external cylindrical surface would be, if this speed setpoint were reached, greater than the linear speed setpoint VL4. However, the method is designed in such a way that this secondary follower rotational speed setpoint Rc22 of the secondary follower roll, here the second backing roll 22, is not reached.

Indeed, the method 300 comprises, in the repeating step 330, in addition to the steps 3310, 3320, 3330 described above, also the following steps, according to the predetermined piloting frequency:
a. determining 3311 the torque T20 exerted on the follower roll 20 by the follower motor M20;
b. multiplying 3321 the follower torque T20 by a torque coefficient Tf less than 1, to obtain a secondary follower torque limit setpoint Tc22 for the secondary follower roll 22;
c. controlling 3331, by the secondary follower control unit UC22, the application by the secondary follower motor M22 of the secondary follower rotational speed setpoint Rc22 and the secondary follower torque limit setpoint Tc22 for the at least one secondary follower roll 22.

In relation to FIG. 18, the method 300 is defined in a fourth variant to be applied to the case of a calendering machine comprising at least one work roll 10, 12 and, associated with said work roll 10, 12, at least two backing rolls 11, 12, respectively upstream 11 and downstream 12, which are parallel to each other, which are parallel to said work roll 10 and which each bear against said work roll 10, each at a bearing zone, respectively upstream C11 and downstream C12, both arranged on a side of said work roll 10 which is opposite the calendering gap with respect to the first axis Y10.

More particularly, it is a particular case of such a variant which is illustrated in FIG. 18, with a machine which includes a first work roll 10 rotating about a first axis Y10, which will hereinafter be considered as being the main roll, and a second work roll 20 rotating about a second axis Y20 parallel to the first axis Y10, which will hereinafter be considered as being a follower roll, the two work rolls 10, 20 being counter-rotating and defining between them a calendering gap 30 in which the strip 4 runs in a running plane PXY along a running direction X from upstream to downstream. For each work roll 10, 12, the machine includes, associated with said work roll 10, 12, at least two backing rolls 11, 12, 21, 22, respectively upstream 11, 21 and downstream 12, 22, which are parallel to each other, which are parallel to said work roll 10, 20 and which each bear against said work roll 10, 20 each at a bearing zone, respectively upstream C11, C21 and downstream C12, C22, both arranged on a side of said work roll 10, 20 which is opposite the calendering gap with respect to the axis Y10, Y20 of said work roll. Examples of such a machine are illustrated in FIGS. 1 to 10 and 12 to 14.

In the general case of such a variant, the method 300 allows the control of the rotation of at least three rolls, including a main roll and two primary follower rolls. The machine includes a main roll, for example the first work roll 10 in the example of FIG. 18, and at least two follower rolls, for example the second work roll 20 and one of the two first backing rolls 11, 12 in the example of FIG. 18. In the example of FIG. 18, the at least three rolls may consist of the first work roll 10, as the main roll, and the two first backing rolls 11, 12 as the two follower rolls. In both cases, the two follower rolls are each mechanically connected to the same main roll, either by direct contact, for example in the case of a work roll and an associated backing roll, or by indirect contact, in the case of two work rolls which are each in contact with one face of a strip moving between the two work rolls, but independently of each other. Thus, among the three considered rolls, none is a secondary follower roll mechanically connected to a follower roll.

This does not prevent the calendering machine illustrated in FIG. 18 from further including at least one secondary follower roll, here the two second backing rolls 21, 22, which are each mechanically linked, independently of one another, in rotation to the follower roll which is the second work roll 20, and which are for example each piloted, independently of one another, in the manner described in relation to FIG. 17.

As regards the method for controlling the two work rolls 10, 20 of the machine of FIG. 18, it is for example identical to that described for these two work rolls in the variant described in relation to FIG. 16, and will therefore not be repeated here. Similarly, as regards the method for controlling the first work roll 10 and the first downstream backing roll 12, it is for example identical to that described for these two work rolls in the variant described in relation to FIG. 17, and will therefore not be repeated here. As regards the method for controlling the first work roll 10 and the first upstream backing roll 11, it is for example identical, mutatis mutandis, to that described for the first work roll 10 and the first downstream backing roll 12, in the variant described in relation to FIG. 15, and will therefore not be unnecessarily developed here. As for the method for controlling the second work roll 20 and the second upstream backing roll 21, it is for example identical, mutatis mutandis, to that described for the second work roll 10 and the second downstream backing roll 22, in the variant described in relation to FIG. 17, and will therefore not be unnecessarily developed here. In all cases, it is noted that the two follower rolls, which are mechanically linked in rotation to the same main roll that is the first work roll 10, are preferably each piloted independently of one another. For each of the two follower rolls, it may be possible to choose to use the same speed coefficient value Sf, or not, and/or it may be possible to choose to use the same torque coefficient value Tf, or not.

Thus, according to one aspect of the invention, there are provided methods (200, 300) for controlling the rotation of at least two rolls of a calendering machine in accordance with one or the other of the clauses below.

In certain variants, there is therefore provided (Clause 1) a method (200, 300) for controlling the rotation of at least two rolls of a calendering machine (1), the calendering machine being of the type including a main roll (10) rotatable about a first axis (Y10), and at least one follower roll (20, 11, 12), the calendering machine (1) comprising a main motor (M10) for driving the main roll, and a follower motor (M20, M11, M12) for driving the at least one follower roll (20, 11, 12), the calendering machine (1) further comprising a main control unit (UC10) for the speed of the main motor (M10), a follower control unit (UC20, UC11, UC12) for the speed and torque of the follower motor (20, 11, 12), characterized in that the method (200, 300) comprises the following steps:
controlling (210, 310), the application by the main motor (M10), of a rotational speed setpoint (Rc10) of the main roll (10) corresponding to a tangential speed setpoint (VL4) for the main roll;
controlling (2330, 3330) the application by the follower motor (M20, M11, M12):
   of a follower rotational speed setpoint (Rc20, Rc11, Rc12) for the follower roll (20, 11, 12) corresponding to the tangential speed setpoint (VL4) multiplied by a speed coefficient (Sf) greater than 1; and
   of a follower torque limit setpoint (Tc20, Tc11, Tc12) for the at least one follower roll (20, 11, 12) which is less than the main torque (T10) exerted on the main roll (10) by the main motor (M10).

In certain variants, there is therefore proposed (Clause 2) a method (300) for controlling the rotation of at least three rolls of a calendering machine (1) which incorporates the features described above (clause 1), the calendering machine further including at least one secondary follower roll (21, 22),
the calendering machine (1) comprising a secondary follower motor (M21, M22) for driving the at least one secondary follower roll (21, 22),
characterized in that the method (300) further comprises at least one step of controlling (3331) the application by the secondary follower motor (M21, M22):
   of a secondary follower rotational speed setpoint (Rc21, Rc22) corresponding to the tangential speed setpoint (VL4) multiplied by a speed coefficient (Sf) greater than 1;
   and of a secondary follower torque limit setpoint (Tc21, Tc22) for the at least one secondary follower roll (21, 22) which is less than the follower torque (T20) exerted on the follower roll (20) by the main motor (M20).

In certain variants, and according to a more particular aspect, there is therefore proposed (Clause 3) a method (200, 300) for controlling the rotation of at least two rolls of a calendering machine (1), the calendering machine being of the type including a main roll (10) rotating about a first axis (Y10), and at least one follower roll (20, 11, 12),
the calendering machine (1) comprising a main motor (M10) for driving the main roll, and a follower motor (M20, M11, M12) for driving the at least one follower roll (20, 11, 12),
the calendering machine (1) further comprising a main control unit (UC10) for the speed of the main motor (M10), a follower control unit (UC20, UC11, UC12) for the speed and torque of the follower motor (20, 11, 12),
characterized in that the method (200, 300) comprises the following steps:
   controlling (210, 310), by the main control unit (UC10), the application by the main motor (M10) of a rotational speed setpoint (Rc10) of the main roll (10) corresponding to a tangential speed setpoint (VL4) for the main roll;
   calculating (220, 320) a follower rotational speed setpoint (Rc20, Rc11, Rc12) for the follower roll (20, 11, 12) corresponding to the tangential speed setpoint (VL4) multiplied by a speed coefficient (Sf) greater than 1;
   repeating (230, 330) the following steps, according to a predetermined piloting frequency:
      determining (2310, 3310) the main torque (T10) exerted on the main roll (10) by the main motor (M10);
      multiplying (2320, 3320) the main torque (T10) by a torque coefficient (Tf) less than 1, to obtain a follower torque limit setpoint (Tc20, Tc11, Tc12) for the follower roll (20, 11, 12);
      controlling (2330, 3330), by the follower control unit (UC20, UC11, UC12), the application by the follower motor (M20, M11, M12) of the follower rotational speed setpoint (Rc20, Rc11, Rc12) and of the follower torque limit setpoint (Tc20, Tc11, Tc12) for the at least one follower roll (20, 11, 12).

In certain variants, and according to a more particular aspect, there is therefore proposed (Clause 4) a method (300) for controlling the rotation of at least three rolls of a calendering machine (1) which incorporates the features described above (clause 3), the calendering machine further including at least one secondary follower roll (21, 22),
the calendering machine (1) comprising a secondary follower motor (M21, M22) for driving the at least one secondary follower roll (21, 22),
the calendering machine (1) further comprising a secondary follower unit (UC21, UC22) for controlling the speed and torque of the secondary follower motor (22),
characterized in that the method (300) comprises the following steps:
   calculating (321) a secondary follower rotational speed setpoint (Rc21, Rc22) for the secondary follower roll (21, 22) corresponding to the tangential speed setpoint (VL4) multiplied by a speed coefficient (Sf) greater than 1;
   repeating (330) the following steps, according to a predetermined piloting frequency:
      determining (3311) the torque (T20) exerted on the follower roll (20) by the follower motor (M20);
      multiplying (3321) the follower torque (T20) by a torque coefficient (Tf) less than 1, to obtain a secondary follower torque limit setpoint (Tc21, Tc22) for the secondary follower roll (21, 22);
      controlling (3331), by the secondary follower control unit (UC21, UC22), the application by the secondary follower motor (M21, M22) of the secondary follower rotational speed setpoint (Rc21, Rc22) and of the secondary follower torque limit setpoint (Tc21, Tc22) for the at least one secondary follower roll (21, 22).

In certain variants, there is therefore proposed (Clause 5) a method (200, 300) for controlling the rotation of at least two rolls of a calendering machine (1) which incorporates the features described above for any one of the above methods (therefore according to any one of clauses 1 to 4), the machine including a first work roll (10) rotating about a first axis (Y10) and a second work roll (20) rotating about a second axis (Y20) parallel to the first axis (Y10), the two work rolls (10, 20) being counter-rotating and defining between them a calendering gap (30) in which a strip (4) to be calendered runs in a running plane (PXY) along a running direction (X) from upstream to downstream,
characterized in that the first work roll is the main roll and the second work roll is a follower roll.

In certain variants, there is therefore proposed (Clause 6) a method (200, 300) for controlling the rotation of at least two rolls of a calendering machine (1) which incorporates the features described above for the previous method (i.e. according to clause 5), characterized in that the machine includes at least one backing roll (11, 12), which is parallel to the first work roll (10) and which bears against the first work roll (10), at a bearing zone (C11, C12), arranged on a side of the first work roll (10), and in that the first work roll is the main roll and the at least one backing roll (11, 12) is a follower roll.

In certain variants, there is therefore proposed (Clause 7) a method (200, 300) for controlling the rotation of at least two rolls of a calendering machine (1) which incorporates the features described above for the method according to clause 5, characterized in that the calendering machine (1) includes, associated with the first work roll (10), at least two backing rolls (11, 12), respectively upstream (11) and downstream (12), which are parallel to each other, which are parallel to the first work roll (10) and which each bear against the first work roll (10), each at a bearing zone (C11, C12), respectively upstream (C11) and downstream (C12), both arranged on a side of the first work roll (10) which is opposite the calendering gap with respect to the first axis (Y10), in that the first work roll is the main roll, in that each backing roll (11, 12) is a follower roll of the main roll.

In certain variants, there is therefore provided (Clause 8) a method (300) for controlling the rotation of at least two rolls of a calendering machine (1) which incorporates the features described above for the method according to clause 5, characterized in that the machine includes at least one backing roll (21, 22), which is parallel to the second work roll (20) and which bears against the second work roll (20), at a bearing zone (C21, C22), arranged on a side of the second work roll (20), and in that the second work roll is a follower roll and the at least one backing roll (11, 12) is a secondary follower roll.

In certain variants, there is therefore proposed (Clause 9) a method (300) for controlling the rotation of at least two rolls of a calendering machine (1) which incorporates the features described above for the method according to clause 5, characterized in that the calendering machine (1) includes, associated with the second work roll (20), at least two backing rolls (21, 22), respectively upstream (21) and downstream (22), which are parallel to each other, which are parallel to the second work roll (20) and which each bear against the second work roll (20), each at a bearing zone (C21, C22), respectively upstream (C21) and downstream (C22), both arranged on a side of the second work roll (20) which is opposite the calendering gap with respect to the first axis (Y20), in that the second work roll is a follower roll, in that each backing roll (21, 22) is a secondary follower roll of the second work roll (20).

In certain variants, there is therefore proposed (Clause 10) a control method (200, 300) which incorporates the features described above for any of the methods above (therefore according to one of the preceding clauses), in which the predetermined control frequency is greater than one measurement per millisecond, preferably greater than one measurement per microsecond.

Examples of application of one or more of the teachings concerning the above machines and methods will now be described.

FIG. 21 illustrates an example of an installation 1000 for the continuous production of a film 4 formed from a self-supporting layer of a material obtained by calendering a powder, said installation 1000 comprising at least one calendering machine 1 of the type described above and capable of implementing a control method as described above.

The film 4 is, for example, a layer of self-supporting electrode material, which is introduced into the calendering machine 1 in powder form, which is calendered there alone, possibly with the addition of heat, to give cohesion to the layer of electrode material.

The electrode material may for example comprise an electrode active material associated with a binder, for example a fibrillable binder. The electrode active material may for example be or comprise a lithium metal oxide (for example of the NMC, NCA or LFP type) and/or graphite and/or activated carbon in the case of a cathode, or graphite or silicon in the case of an anode. The fibrillable binder may for example be or comprise polytetrafluoroethylene (PTFE), polyvinylpyrrolidone (PVP), polyvinylidene fluoride (PVDF), polyethylene oxide (PEO), polyethylene (PE) and/or carboxymethylcellulose (CMC), or a combination thereof. The fibrillable binders can be characterized by their soft, flexible, and pliable consistency and, in particular, by their ability to stretch, elongate, and become thinner and take on a fibrous appearance when subjected to shear stresses.

The film thus produced is preferably an electrochemical cell component, in particular an electrode component for electrochemical cells, particularly for electrochemical cells of electric storage batteries, in particular of the lithium-ion type.

The installation 1000 includes at least one film forming section 1200. For example, the installation 1000 may include, successively, a feed section 1100, a film forming section 1200, a film extraction section 1300, and a film finishing section 1400.

The film forming section 1200 comprises a main calendering machine 1 which may advantageously be in accordance with any one of the variants described above. The main calendering machine 1 is for example under the form of a machine in accordance with one or the other of the examples described in relation to one or the other of FIGS. 1 to 10 or 12 to 14. This main calendering machine 1 may implement one or the other of the methods described above, in particular described with reference to one of FIGS. 11 and 15 to 20.

The main calendering machine 1 is arranged such that the transverse direction Y of the axes Y10, Y20 of the two work rolls 10, 20 is horizontal and the running direction X is vertical. The running plane PXY is therefore vertical. As a result, the two work rolls 10, 20 delimit, between their outer cylindrical surfaces, just upstream of the calendering gap 30, an upstream space 31 which is arranged vertically just above the calendering gap 30 and which extends transversely over the transverse dimension of the axis of the work rolls 10, 20. The upstream space 31, delimited by the outer cylindrical surfaces of the two work rolls 10, 20, therefore has, in transverse view, a funnel profile and extends transversely over the transverse dimension of the work rolls 10, 20, this funnel profile opening downwards, at its point of convergence, into the calendering gap 30.

The main calendering machine 1 is continuously fed by the feed section 1100 which continuously discharges into the upstream space 31, preferably in a controlled manner, preferably by the simple operation of the Earth's gravity, a material in powder form, namely the material which is intended to form the self-supporting layer, for example the active electrode material. By gravity, and by the driving effect of the counter-rotating movement of the work rolls 10, 20, the material in powder form is driven from the upstream space 31 into the calendering gap 30 in which the calendering pressure generates an agglomeration of the material, to the point of forming, downstream of the calendering gap 30, a self-supporting film 4 of the material forming a strip having sufficient cohesion to be able to be taken up by the following sections of the installation 1000, for example here the finishing section 1400. For the remainder of the description, it will be assumed that the film 4 thus formed has, in the transverse direction, a film-forming width. Typically, this film-forming width can be comprised between 5 cm and 300 cm, for example between 50 cm and 150 cm. Upstream of the calendering gap 30, the strip 4 within the meaning of the present text is therefore made up of a layer or quantity of powder or mixture comprising one or more powders, for example delivered by the feed section 1100 over a work width at the entrance to the calendering gap 30, the powder or mixture comprising one or more powders still being non-agglomerated, or only partially agglomerated, the powder being agglomerated by calendering in the calendering gap to form the film 4 which constitutes the strip downstream of the calendering gap.

The feed section 1100 comprises, for example, a linear metering unit 1120 which delivers, onto a conveyor belt 1140 having a width in the transverse direction Y greater than the film-forming width, a regular layer of powder. The metering unit includes, for example, a powder reservoir 1122 and at least one metering roll 1124, which is arranged vertically under the powder reservoir 1122 and which rotates about its transverse axis so as to receive from the reservoir 1122 a quantity of powder and to discharge it regularly, over the formation width, onto the conveyor belt 1140, an upstream part of which is arranged under the metering roll 1124. The conveyor belt 1140 extends along a substantially horizontal plane here and runs along this plane from its upstream part to a downstream discharge end 1142 at which the powder deposited on the conveyor belt 1140 is discharged, preferably by gravity, into a hopper 1160 conducting and discharging the powder into the upstream space 31 of the main calendering machine 1. Preferably, a sensor 1180 is provided for determining the instantaneous quantity of powder contained in the upstream space 31, for example a level sensor, for example an optical sensor. The installation 1000 preferably includes an electronic control unit which is capable of controlling the linear metering unit 1120, for example by controlling the rotational speed of the metering roll 1124, and/or by controlling the conveyor belt 1140, for example by controlling a running speed of the conveyor belt 1140, to maintain the instantaneous quantity of powder contained in the upstream space 31 within an optimal range of values, as the powder is driven from the upstream space 31 into the calendering gap 30 of the main calendering machine 1.

In the main calendering machine 1, a dynamic adjustment of the relative position of the two work rolls 10, 20 is preferably provided during a production phase, in order to adapt in real time the spacing between the two work rolls 10, 20 at the calendering gap 30, in particular to be adapted to variations in calendering conditions as the material runs and the film 4 is formed through the calendering gap 30. In the illustrated example, the dynamic adjustment of the relative position of the two work rolls 10, 20 can be controlled by a measurement representative of the thickness of the film 4. For example, the measurement representative of the thickness of the film 4 can be obtained using one or more sensors, which can for example be or comprise one or more film thickness sensors 4 and/or which can for example be or comprise one or more sensors of a distance representative of the work spacing between the two rolls 10, 20. In the example, it has been illustrated that the main calendering machine can be equipped with a cleaning device 1240 for the external cylindrical work surface of the work rolls 10, 20. The cleaning device 1240 can include, for each work roll 10, 20, one or more scrapers which rub against the external cylindrical work surface of the roll in order to sweep away any residue, in particular powder residue. The cleaning device 1240 can be associated with a recovery device 1260, in particular a suction recovery device, to collect these residues, with possibly a possibility of recycling these residues.

In the example illustrated in the figures, the extraction section 1300 of the installation 1000 is designed to continuously recover the film 4 which is produced in the main calendering machine 1, at the outlet downstream of the calendering gap 30. In the example, the extraction section 1300 includes a downstream support and/or guide device which supports and/or guides the film downstream of the calendering gap. In the example, the downstream support and/or guide device is in the form of a conveyor belt 1320 which here extends along a substantially horizontal plane from an upstream end 1322 to a downstream end 1324. The conveyor belt 1320 has a running speed which is substantially equal to the running speed of the film 4 through the calendering gap 30.

According to one aspect, in the extraction section 1300, the film 4 has, immediately upon exiting the calendering gap 30, a free section 401 along which the film 4 is not in contact with any element, therefore with any support or guide element. In the example, the free section 401 of the film 4 extends from the calendering gap 30 to the conveyor belt 1320. Advantageously, the free section 401 of the film 4 has a length which is at least 20 centimeters, preferably at least 50 centimeters. For example, the free section 401 of the film 4 has a length comprised between 20 centimeters and 200 centimeters, preferably comprised between 50 centimeters and 150 centimeters.

In the example, in continuous operation, the free section 401 of the film 4 does not extend vertically, and does not extend along a straight line but extends along a curved line between the calendering gap 30 and a recovery point, which is here for example the upstream end 1322 of the conveyor belt 1320, at which the film 4 comes into contact with the device for supporting and/or guiding the film 4. Thus, in the example, the length of the free section 401 of the film 4 is strictly greater than the straight line distance between the calendering gap 30 and the take-up point. The tension of the free section 401 of the film 4, and therefore the length of the free section of the film, depend in particular on the running speed of the film 4 through the calendering gap and on one or more operational parameters of the downstream support and/or guide device, for example the running speed of the conveyor belt 1320. Adjusting one or the other of the running speed of the film 4 through the calendering gap 30 and the operational parameter(s) of the downstream support and/or guide device makes it possible to adjust the tension and/or the length of the free section 401 of the film 4, and makes it possible to optimize the operation of forming the film 4 in the main calendering machine 1.

The presence of a free section 401 along which the film 4 is not in contact with any element, immediately downstream of the calendering gap, makes it possible to have, opposite this free section 401, one or more sensors 1310 for measuring at least one feature of the film 4 such as a dimensional feature (width, thickness, etc.), a rheological, tribological feature (surface condition, etc.), a temperature feature, etc. Such measurements can be carried out continuously, or at least with a high frequency, greater than 1 Hz, preferably equal to or greater than 500 Hz, more preferably greater than 1 KHz. Such measurements, immediately downstream of the calendering gap 30, and preferably at such high frequencies, can be used for fine control of the installation, in particular fine control of the calendering operation in the calendering machine 1, in particular fine adjustment of at least one of the operational parameter(s) of the feed section 1100, for example those described above, and/or of the operational parameter(s) of the forming section 1200, for example the running speed of the film 30 in the calendering gap 30 or the work gap in the calendering gap 30, and/or of the operational parameter(s) of the extraction section 1300 and/or of the finishing section 1400.

In the example, the finishing section 1400 includes at least one secondary calendering machine 1420 within which the film can undergo a densification operation. The finishing section 1400 may however include several successive secondary calendering machines within which the film 4 can then undergo several successive densification operations. In the example, the secondary calendering machine 1420 is a 4-roll machine, with two work rolls and, for each work roll, a single backing roll. However, as a variant, the secondary calendering machine may be a machine including, for at least one work roll, several backing rolls, for example a calendering machine of the type described with reference to at least one of FIGS. 1 to 10 or 12 to 14.

In the illustrated example, the finishing section 1400 includes at least one tension regulator for the film 4, for example a tension regulator 1415 upstream of a secondary calendering machine 1420 and/or a tension regulator 1425 downstream of a secondary calendering machine 1420. A tension regulator 1415, 1425 includes, for example, a rotating roll 1416, 1426 mounted at the movable end of a rocker 1417, 1427, the rocker 1417, 1427 pressing the rotating roll 1416, 1426 against the film 4 with a force, perpendicular to the film 4, which is preferably adjustable, preferably dynamically adjusted as a function of operational parameters of the installation or measured feature of the film 4. Furthermore, such a rotating roll 1416, 1426 may also be provided with a brake, preferably of adjustable intensity, to adjust a tension differential of the film 4 between the upstream and downstream of this roll.

The finishing section 1400 may include other elements, such as, for example, a strip edge cutting device and/or a winding device.

1. A calendering machine (1) for calendering a strip (4) to be calendered, of the type including a first work roll (10) rotatable about a first axis (Y10) and a second work roll (20) rotatable about a second axis (Y20) parallel to the first axis (Y10), the two work rolls (10, 20) being counter-rotating and defining between them a calendering gap (30) in which the strip (4) runs in a running plane (PXY) along a running direction (X) from upstream to downstream,
characterized in that the calendering machine (1) includes, associated with the first work roll (10), at least two backing rolls (11, 12), respectively upstream (11) and downstream (12), which are parallel to each other, which are parallel to the first work roll (10) and which each bear against the first work roll (10), each at a bearing zone (C11, C12), respectively upstream (C11) and downstream (C12), both arranged on a side of the first work roll (10) which is opposite the calendering gap with respect to the first axis (Y10).

2. The calendering machine (1) according to claim 1, characterized in that each backing roll (11, 12) associated with the first work roll (10) has an external bearing surface (S11, S12) which bears on the associated work roll (10), and in that the shortest distance (d11) between the external bearing surface (S11) of the upstream backing roll (11) and the running plane (PXY) is greater than the shortest distance (d12) between the external bearing surface (S12) of the downstream backing roll (12) and the running plane (PXY).

3. The calendering machine (1) according to any one of claim 1 or 2, characterized in that the machine (1) has a first upstream tangent plane (Pt11), tangent on the downstream side to both the first work roll (10) and the associated upstream backing roll (11), which forms a first upstream clearance angle (w11) with the running plane (PXY), and a first downstream tangent plane (Pt12), tangent on the downstream side to both the first work roll (10) and the associated downstream backing roll (C12), which forms a first downstream clearance angle (w12) with the running plane (PXY), and in that the first upstream clearance angle (w11) is greater than the first downstream clearance angle (w12).

4. The calendering machine (1) according to any one of the preceding claims, characterized in that the bearing zones (C11, C12) of the two backing rolls (11, 12) associated with the first work roll (10) are angularly spaced from each other, about the first axis (Y10), by a first bearing spacing angle (a10) which is within the range of 30 to 120 degrees, preferably within the range of 60 to 100 degrees.

5. The calendering machine (1) according to any one of the preceding claims, characterized in that the bearing zones (C11, C12) of the two backing rolls (11, 12) associated with the first work roll (10) are arranged symmetrically with respect to each other on either side of a work plane (PYZ) comprising the first axis (Y10) and the second axis (Y20), and in that the bisector (B10) of the first bearing spacing angle (a10) has a direction which is inclined downstream away from the running plane (PXY).

6. The calendering machine (1) according to any one of the preceding claims, characterized in that the upstream backing roll (11) associated with the first work roll (10) has an external diameter (DE11) which is less than the external diameter (DE12) of the downstream backing roll (12) associated with the first work roll (10).

7. The calendering machine (1) according to any one of the preceding claims, characterized in that the calendering machine (1) includes, associated with the second work roll (20), two backing rolls (21, 22), respectively upstream (21) and downstream (22), which are parallel to each other, which are parallel to the second work roll (20) and which each bear against the second work roll (20), each at a bearing zone (C21, C22), respectively upstream (C21) and downstream (C22), arranged on a side of the second work roll (20) which is opposite the calendering gap (30) relative to the second axis (Y20).

8. The calendering machine (1) according to any one of the preceding claims, characterized in that a considered work roll (10, 20) is movable relative to the associated backing group between a relative closed position in which the considered work roll (10, 20) and the two backing rolls (11, 12, 21, 22) associated with the considered work roll (10, 20) are in a relative contact position, and a relative spaced-apart position in which the considered work roll (10, 20) and the two backing rolls (11, 12, 21, 22) associated with the considered work roll (10, 20) are in a relative spaced-apart position.

9. The calendering machine (1) according to claim 8, characterized in that the considered work roll (10) is rotatably mounted on a corresponding work support (14, 24), in that the two backing rolls (11, 12) associated with the considered work roll (10, 20) are each rotatably mounted about its own axis on a corresponding backing support (19) and in that at least one of the work support and the corresponding backing support is carried by a guide mechanism (17, 27), by which the corresponding work support (14) is movable relative to the corresponding backing support (19) between a relative closed position in which the considered work roll (10, 20) and the two backing rolls (11, 12, 21, 22) associated with the considered work roll (10, 20) are in a relative contact position, and a relative spaced-apart position in which the considered work roll (10, 20) and the two backing rolls (11, 12) associated with the considered work roll (10, 20) are in their relative spaced-apart position.

10. The calendering machine (1) according to claim 9, characterized in that the work support (14, 24) corresponding to the considered roll (10, 20) is movable, relative to the corresponding backing support (19, 29) and relative to a frame (2) of the machine.

11. The calendering machine (1) according to any one of claim 9 or 10, characterized in that the guide mechanism (17, 27) is carried by the backing support (19, 29) corresponding to the considered work roll (10, 20) and in that the corresponding work support (14, 24) is mounted on the corresponding backing support (19) by means of the guide mechanism (17, 27) which is carried by the corresponding backing support (19) and which is separate from a frame (2) of the machine.

12. The calendering machine (1) according to claim 11, characterized in that the work roll (10, 20) and the corresponding work support (14, 24) are without direct guidance on the frame (2) of the machine.

13. The calendering machine (1) according to any of claims 9 to 12, characterized in that the backing support (19, 29) corresponding to the considered work roll (10, 20) is movable relative to the frame (2) and in that the guide mechanism (17, 27) is movable with the backing support (19, 29) relative to the frame (2).

14. The calendering machine (1) according to any one of claims 9 to 10, characterized in that the guide mechanism is carried by the frame (2) of the machine and in that the work support (14, 24) is mounted on the frame (2) by means of the guide mechanism.

15. The calendering machine (1) according to any of claims 9 to 14, characterized in that the guide mechanism (17, 27, 37, 47) allows a single degree of freedom of the first work support (14) relative to the first backing support (19).

16. The calendering machine (1) according to any one of claims 9 to 15, characterized in that the first guide mechanism (17) only allows a translation of the first work support (14) relative to the first backing support (19) in a radial direction perpendicular to the first axis (Y10) and parallel to a calendering plane (PYZ) containing the two axes (Y10, Y20) of the two work rolls (10, 20).

17. A method for calendering a strip (4) to be calendered, of the type in which the strip (4) is caused to run, in a running plane (PXY) along a running direction (X) from upstream to downstream, through a calendering gap (30) defined between a first work roll (10) rotating about a first axis (Y10) and a second work roll (20) rotating about a second axis (Y20) parallel to the first axis (Y10), the two work rolls (10, 20) being counter-rotating,
characterized in that the method includes the application, on the first work roll (10), of at least two backing rolls (11, 12), respectively upstream (11) and downstream (12), which are parallel to each other, which are parallel to the first work roll (10) and which each bear against the first work roll (10), each at a bearing zone (C11, C12), respectively upstream (C11) and downstream (C12), both arranged on a side of the first work roll (10) which is opposite the calendering gap with respect to the first axis (Y10).

18. The calendering method according to claim 16, characterized in that each backing roll (11, 12) associated with the first work roll (10) has an external bearing surface (S11, S12) which bears on the associated work roll (10), and in that the two backing rolls are applied to the work roll (10) in such a way that the shortest distance (d11) between the external bearing surface (S11) of the upstream backing roll (11) and the running plane (PXY) is greater than the shortest distance (d12) between the external bearing surface (S12) of the downstream backing roll (12) and the running plane (PXY).

19. The calendering method (100) according to claim 18, characterized in that the second work roll (20) is movable, perpendicular to the running plane (PXY).

20. The calendering method (100) according to any one of claim 18 or 19, characterized in that the calendering method (1) includes the application, bearing against the second work roll (20), of two backing rolls (21, 22), respectively upstream (21) and downstream (22), which are associated with the second work roll (20), which are parallel to each other, which are parallel to the second work roll (20) and which each bear against the second work roll (20), each at a bearing zone (C21, C22), respectively upstream (C21) and downstream (C22), both arranged on a side of the second work roll (20) which is opposite the calendering gap (30) relative to the second axis (Y20).
